(19) United States
(12) Patent Application Publication
(10) Pub. No.: US 2026/0277701 A1
(43) Pub. Date: Sep. 17, 2026

(54) SYSTEM AND METHOD FOR SEAMLESSLY CORRELATING CLOUD ASSETS TO INFRASTRUCTURE AS CODE (IAC) DEFINITIONS USING STATE RECORDS

(71) Applicant: Orca Security Ltd., Tel Aviv-Yafo (IL)

(72) Inventors: Yinon SHARIFI, Rosh Haayin (IL); Yoav ALON, Giv'atayim (IL); Lior SAMUNI, Giv'atayim (IL); Roi LUBETKIN, Netanya (IL)

(73) Assignee: Orca Security Ltd., Tel Aviv-Yafo (IL)

(21) Appl. No.: 19/565,077

(22) Filed: Mar. 12, 2026

Related U.S. Application Data
(60) Provisional application No. 63/770,685, filed on Mar. 12, 2025.

(51) Int. Cl. G06F 9/50; G06F 21/57; G06N 5/01

(52) U.S. Cl. CPC G06F 9/5072; G06F 9/5027; G06F 21/577; G06N 5/01

(57) ABSTRACT

Systems, methods, and computer readable medium are disclosed for identifying infrastructure-as-code (IaC) associated with cloud assets. Identifying lac associated with cloud assets includes locating IAC state data; analyzing the IAC state data to identify attributes of associated provisioned resources, wherein the IAC state data lacks manually introduced tags; accessing the provisioned resources; establishing a first map between the IAC state data and the provisioned resources based on the identified attributes; accessing a set of IAC code definitions; establishing a second map between the IAC state data and the set of IAC code definitions; and based on the first map and the second map, establishing a third map between the set of IAC code definitions and the provisioned resources, thereby mapping the set of IAC code definitions to the provisioned resources without requiring manual tagging of the provisioned resources.

This application claims the benefit of priority of U.S. Provisional Patent Application No. 63/770,685, filed on Mar. 12, 2025, which is incorporated herein by reference in its entirety.

### TECHNICAL FIELD

The present disclosure generally relates to cloud computing and Development and Operations (DevOps) practices, and more specifically to seamlessly correlating cloud assets to their originating infrastructure as code (IaC) definitions without requiring manual tagging or labeling of resources.

### BACKGROUND

As organizations increasingly adopt cloud computing and DevOps methodologies, managing cloud assets becomes critical. Traditional infrastructure management methods are often inadequate for the dynamic and scalable nature of cloud environments. Infrastructure as Code (IaC) has emerged as a solution for programmatically defining and managing cloud infrastructure. However, correlating deployed cloud assets to their originating IaC definitions remains a significant challenge, especially in large-scale and rapidly evolving environments.

Current solutions often rely on manual tagging or labeling of resources, which is error-prone, time-consuming, and difficult to maintain at scale. Additionally, these methods may not capture the full complexity of relationships between IaC definitions and deployed assets, particularly in cases of dynamic provisioning or when dealing with multi-cloud environments.

### SUMMARY

Some disclosed embodiments may include a system for identifying infrastructure-as-code (IAC) associated with cloud assets. The system includes at least one processor configured to locate IAC state data; analyze the IAC state data to identify attributes of associated provisioned resources, wherein the IAC state data lacks manually introduced tags; access the provisioned resources; establish a first map between the IAC state data and the provisioned resources based on the identified attributes; access a set of IAC code definitions; establish a second map between the IAC state data and the set of IAC code definitions; and based on the first map and the second map, establish a third map between the set of IAC code definitions and the provisioned resources, thereby mapping the set of IAC code definitions to the provisioned resources without requiring manual tagging of the provisioned resources.

The foregoing general description of the illustrative embodiments and the following detailed description thereof are merely exemplary aspects of the teachings of this disclosure and are not restrictive.

### BRIEF DESCRIPTION OF THE FIGURES

The accompanying drawings, which are incorporated in and constitute a part of this disclosure, illustrate various disclosed embodiments. In the drawings:

FIG. 1 is a schematic diagram of an exemplary computing device, consistent with some disclosed embodiments.

FIG. 2 is a schematic diagram of a plurality of first computing devices in communication with a plurality of second computing devices over an exemplary communications network, consistent with some disclosed embodiments.

FIG. 3 is a schematic diagram of an exemplary system for identifying Infrastructure as Code (IaC) associated with cloud assets, consistent with some disclosed embodiments.

FIG. 4 is a schematic diagram of a plurality of exemplary maps for identifying IaC associated with cloud assets, consistent with some disclosed embodiments.

FIG. 5 is a depiction of an exemplary interactive user interface presenting the first, second, and third maps, consistent with some disclosed embodiments.

FIG. 6 is a flowchart of example process for identifying infrastructure-as-code (IAC) associated with cloud assets, consistent with some disclosed embodiments of the present disclosure.

### DETAILED DESCRIPTION

The following detailed description includes references to the accompanying drawings. Wherever possible, the same reference numbers are used in the drawings and the description to refer to the same or similar parts. While several illustrative embodiments are described herein, modifications, adaptations, and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Various terms used in the specification and claims may be defined or summarized differently when discussed in connection with differing disclosed embodiments. It is to be understood that the definitions, summaries, and explanations of terminology in each instance apply to all instances, even when not repeated, unless the transitive definition, explanation, or summary would result in inoperability of an embodiment. It is also to be understood that once a term is defined herein, in the absence of an inherent inconsistency, that definition applies to all other uses of the term herein. Moreover, the exemplary embodiments of the figures and their description are not to be considered definitions of claim terms, but rather are non-limiting examples used to illustrate specific embodiments.

Throughout, this disclosure mentions “embodiments” and “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure employs open-ended permissive language, indicating for example, that some embodiments “may” employ, involve, or include specific features. The use of the term “may,” and other open-ended terminology, is intended to indicate that although not every embodiment may employ the specific disclosed feature, at least one embodiment employs the specific disclosed feature.

Some embodiments may involve a computing device. A computing device as used herein may include any type of device capable of executing instructions using at least one processor. Such a computing device may include a smartphone, a tablet, a smartwatch, a personal digital assistant, a desktop computer, a laptop computer, an IoT device, a dedicated terminal, a wearable computing device, a client device, a server, and/or any other electronic device that enables computation. A computing device may include at least one processor, at least one memory, a transceiver, and an input/output unit, all interconnected via one more buses.

The at least one processor may include any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all, or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor may include a remote processing unit (e.g., a “cloud computing” resource) accessible via a communications network.

The at least one memory may include a Random Access Memory (RAM), a Read-Only Memory (ROM), a hard disk, an optical disk, a magnetic medium, a flash memory, other permanent, fixed, or volatile memory, or any other mechanism capable of storing instructions. Such a memory may be pre-loaded with instructions for execution by at least one processor. In some embodiments, the at least one memory may include a remote storage (e.g., “cloud” storage) accessible via a communications network.

In some embodiments, a computing device may include a communications device capable of exchanging data using a wired and/or wireless communications network. Such a communications network may include one or more of a digital communications network, an analog communication network, and/or any other communications network configured to convey data. Some examples of communications networks may include the Internet, a private data network, a virtual private network using a public network, a Wi-Fi network, a LAN, or WAN network, and/or any combination thereof. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LET (BLE), Wi-Fi, near field communications (NFC), or other suitable communication methods that provide a medium for exchanging data and/or information between separate entities.

Differing embodiments of this disclosure may involve systems, methods, and/or computer readable media containing instructions. A system refers to at least two interconnected or interrelated components or parts that work together to achieve a common objective, function, or subfunction. A method refers to at least two steps, actions, or techniques to be followed in order to complete a task or a sub-task, to reach an objective, or to arrive at a next step. Computer-readable media containing instructions refers to any storage mechanism that contains program code instructions, for example to be executed by a computer processor. Examples of computer-readable media are further described elsewhere in this disclosure. Instructions may be written in any type of computer programming language, such as an interpretive language (e.g., scripting languages such as HTML and JavaScript), a procedural or functional language (e.g., C or Pascal that may be compiled for converting to executable code), an object-oriented programming language (e.g., Java or Python), a logical programming language (e.g., Prolog or Answer Set Programming), and/or any other programming language. Instructions executed by at least one processor may include implementing one or more program code instructions in hardware, in software (including in one or more signal processing and/or application specific integrated circuits), in firmware, or in any combination thereof, as described earlier. Causing a processor to perform operations may involve causing the processor to calculate, execute, or otherwise implement one or more arithmetic, mathematic, logic, reasoning, or inference steps.

In some embodiments, one or more neural networks may be configured to analyze inputs and generate corresponding outputs. Some non-limiting examples of such neural networks may include shallow artificial neural networks, deep artificial neural networks, feedback artificial neural networks, feed-forward artificial neural networks, autoencoder artificial neural networks, probabilistic artificial neural networks, time-delay artificial neural networks, convolutional artificial neural networks, recurrent artificial neural networks, long/short term memory artificial neural networks, and so forth. In some examples, an artificial neural network may be configured manually. For example, a structure of the artificial neural network may be selected manually, a type of an artificial neuron of the artificial neural network may be selected manually, a parameter of the artificial neural network (such as a parameter of an artificial neuron of the artificial neural network) may be selected manually, and so forth. In some examples, an artificial neural network may be configured using a machine learning algorithm. For example, a user may select hyper-parameters for the artificial neural network and/or the machine learning algorithm, and the machine learning algorithm may use the hyper-parameters and training examples to determine the parameters of the artificial neural network, for example using back propagation, using gradient descent, using stochastic gradient descent, using mini-batch gradient descent, and so forth. In some examples, an artificial neural network may be created from two or more other artificial neural networks by combining the two or more other artificial neural networks into a single artificial neural network.

Some disclosed embodiments involve applying AI functionality to perform one or more procedures disclosed herein. AI functionality may refer to any kind of capability or feature exhibited by an artificial intelligence system. It involves the ability of AI systems to perform tasks that usually require human intelligence. Examples of those tasks may include comprehension of natural language, recognition of patterns or structures in a data set, or the generation of predictions/forecasts. AI functionality incorporates different techniques and technologies such as Natural Language Processing (NLP), Natural Language Generation (NLG), Machine Learning (ML), Neural Network (NN), Deep Learning (DL), Large Language Model (LLM), or Computer Vision. AI functionalities empower applications to analyze, interpret, and generate data, automate processes, optimize performance, and offer intelligent solutions for intricate problems.

Different categories of AI functionality exist, and the exact definitions of these categories remain an open question as categories of Artificial intelligence are not mutually exclusive. AI systems may possess multiple functionalities simultaneously, and their capabilities may span across different areas of AI. For instance, an AI system may have both generative AI functionality to produce new content, such as text or images, and analytical AI functionality to analyze existing data, detect patterns, make decisions, or identify anomalies. These functionalities may be intertwined within a single AI system, allowing it to generate new content while also performing analysis on that content or other data. The field of AI is highly interconnected, and advancements in one area may influence and enhance capabilities in other areas. As AI technologies continue to evolve, the lines between different functionalities may become even more blurred, leading to increasingly integrated and versatile AI systems that combine various capabilities. Therefore, when discussing AI functionalities, it is important to recognize their potential overlap and interplay, as AI systems may exhibit a wide range of capabilities that are not limited to a single category or functionality.

AI assistants may be powered by AI agents, also referred to as AI engines or AI core technology, i.e., components responsible for understanding user inputs, generating appropriate responses, and performing tasks on behalf of the user. An AI agent utilizes artificial intelligence technologies, such as NLP, ML, decision-making algorithms or any of the above-listed AI technologies, to interpret user queries, process information, and provide relevant and context-aware assistance. AI agents within AI assistants may incorporate various components, including perception to understanding user inputs (e.g., speech recognition or text parsing), reasoning and decision-making to generate appropriate responses, and action to execute tasks or interact with external systems. It may also involve learning capabilities to improve performance over time through user interactions and feedback. The AI agent acts as the intelligent core of the AI assistant, enabling it to understand user intent, provide accurate and helpful responses, and perform tasks or services on behalf of the user. It drives the conversational and interactive capabilities of the AI assistant, making it capable of simulating human-like interactions and assisting users with their requests. Non-limiting examples of AI assistants include Apple Siri™, Amazon Alexa™, Microsoft Cortana™, IBM Watson™, OpenAI ChatGPT-4™ and Bard™ Google's Assistant. The specific name or brand of the AI agent behind an AI assistant may vary depending on the developer or company that created it, some may not be publicly disclosed, like Siri's AI agent for example, while others are known, like Google's AI agent that powers Bard™, called Language Model for Dialogue Application (LaMDA). Communication and data exchange between a SaaS platform and an AI agent may be performed in various ways. For example, an AI communication module may be included in the SaaS platform to establish a connection between the SaaS platform and one or more AI agents.

AI agents may specialize in different types of operations or data processing based on their training, the AI technologies employed and their design. Accordingly, AI agents may be programmed and trained to specialize in specific domains, tasks, or industries. For example, different AI agents may specialize in the generation of different types of content such as text, images, and/or code. In another example, different AI agents may be labelled by a specific type of data used in their training set, for example, a first AI agent may be specialized and trained in code generation, a second AI agent may be specialized in predicting compatibility between different software modules, and a third AI agent may specialize in automatically generating a software product based on a requirement specification. Despite the existence of these specialized AI agents, more general and versatile AI agents may handle different types of operations or data. These agents possess broader capabilities and may perform a variety of tasks across different domains. For example, an AI agent may be able to generate both text and visual presentations. It could be trained and programmed to understand natural language and then generate written content. Additionally, it could utilize its visual processing capabilities to create visual presentations or even generate images based on a given input.

Structured data (i.e., a data structure) may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. As used herein, the term “data structure” may include a data pool or may be included in a data pool. A data pool may include a data structure, a data set, a database, a data lake, a data pool, or any other form of information storage whether distributed or undistributed and whether structured or unstructured. It is further to be understood that the term “data structure” as used herein in the singular is inclusive of plural data structures. A data structure may also include any hardware, software, firmware, or combination thereof for storing and facilitating the retrieval of information.

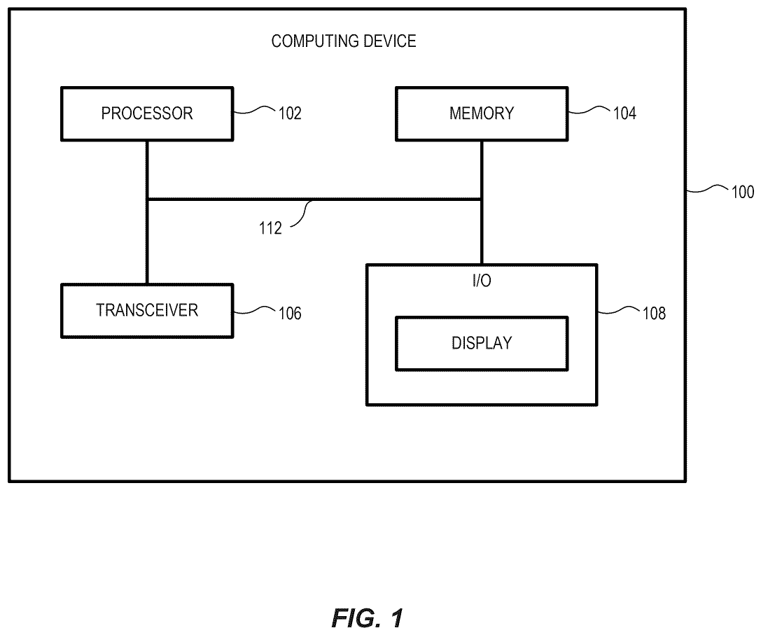

By way of a non-limiting example, reference is made to FIG. 1 illustrating an exemplary schematic diagram of a computing device 100, consistent with some disclosed embodiments. Computing device 100 may include at least one processor 102, at least one memory 104 (e.g., a non-transitory computer readable medium), a transceiver 106, and an input/output (I/O) unit 108. At least one processor 102, at least one memory 104, transceiver 106, and input/output unit 108 may be interconnected via a bus 112. In some embodiments, input/output unit 108 may include a display 110. Display 110 may include one or more touch sensitive surfaces, permitting computing device 100 to receive inputs from a user, and present outputs to a user. Computing device 100 may be configured to perform one or more of the operations disclosed herein.

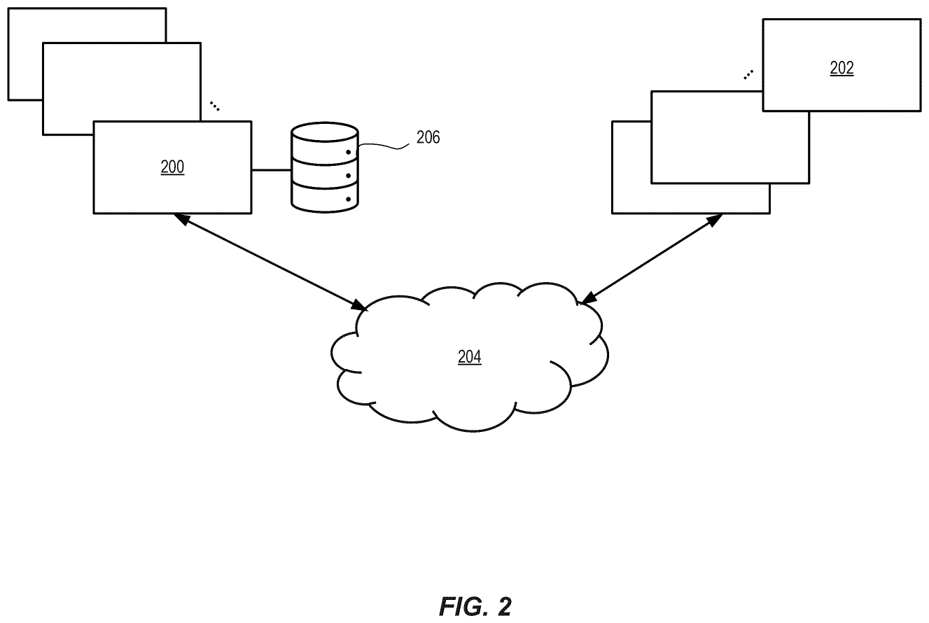

By way of another non-limiting example, reference is made to FIG. 2 illustrating an exemplary schematic diagram of a plurality of first computing devices 200 in communication with a plurality of second computing devices 202 over a communications network 204, consistent with some disclosed embodiments. First and second computing devices 200 and 202 may correspond to different instances of computing device 100 and may exchange data via network 204. In some embodiments, at least some of the data exchanged via network 204 may be stored in at least one data structure 206 (e.g., a data structure). In some embodiments, one or more of first computing devices 200 may be server devices and second computing devices 202 may be client devices. In some embodiments, one or more of first computing device 200 may provide cloud services in conjunction with data structure 206. Computing devices 200 and 202 may be configured to perform one or more of the operations disclosed herein, e.g., in a distributed manner via network 204.

Some disclosed embodiments involve identifying infrastructure-as-code (IaC) associated with cloud assets. Identifying refers to recognizing, ascertaining, and/or discovering. Identifying may include recognizing, determining, and/or distinguishing specific elements, features, or characteristics within a set of data or information. For example, identifying may involve pattern matching, classification, or selection of relevant components from a larger dataset, determining a match (e.g., within a threshold) between two or more items, and/or associating an item with an identifying code and/or index. Infrastructure refers to foundational systems, components, and/or resources that support operation of an environment and/or organization. Infrastructure may enable essential functions and/or services, and may include underlying hardware, software, networks, facilities, and/or related services that provide a base on which applications and/or processes may run. Infrastructure may include a collection of provisioned computing resources and/or supporting components, such as cloud resources, managed services, networking elements, and/or configuration artifacts that may be created, configured, and/or maintained using Infrastructure-as-Code definitions and/or state data to support applications and/or workloads within a computing environment. Some non-limiting examples of infrastructure components include compute resources (e.g., physical servers, virtual machines, containers, serverless execution environments), storage components (e.g., block storage, object storage, file systems, and/or databases), networking components (e.g., routers, switches, load balancers, virtual networks, and/or firewalls), software and/or platform components (e.g., operating systems, middleware, orchestration platforms, and/or management tools), and/or security and access components (e.g., identity and access management services, encryption protocols and/or policies, and/or monitoring systems), and/or any other type of computing infrastructure components.

Infrastructure-as-code (IAC) refers to a methodology for defining, provisioning and/or managing computing infrastructure using machine-readable configuration files instead of manual processes. An IAC methodology may treat definitions for setting up computing infrastructure as executable software source code, enabling automation of version control, reviewing, testing, and/or continuous delivery and/or deployment (CI/CD) of computing infrastructure in a consistent and repeatable manner. For example, instead of manual selection on dashboards to define infrastructure elements (e.g., servers, networks, and/or databases), at least one processor may execute computer code specifying infrastructure needs, enabling automated tools to produce and/or maintain the specified infrastructure. Use of IaC methodology may reduce human error, improve reliability and scalability, reduce configuration drift, and/or permit tracking, auditing, and/or rolling back of infrastructure changes. IaC methodology may permit repeated creation of one or more identical environments during development, staging, and/or production. Some non-limiting examples of infrastructure that may be specified as code may include virtual machines, servers, containers, orchestration platforms, networks, subnets, firewalls, load balancers, databases, storage, and identify and/or access controls.

For example, a configuration file may include a declaration for a desired infrastructure state, e.g.: “create three web servers; attach the web servers to a load balancer; allow HTTPS traffic, provision a database with daily backup.” At least one processor may use the configuration file to compare the desired infrastructure state declared in the configuration file to a current infrastructure state, and apply system changes necessary to transform the current infrastructure state to the desired infrastructure state in a consistent and reproducible manner. Some non-limiting examples of tools for implementing IaC include Terraform®, AWS CloudFormation®, Azure Resource Manager®, Pulumi®, and Ansible®. IaC tools may be declarative, permitting a user to define what the infrastructure will look like, or imperative, permitting a user to define how to generate the infrastructure (e.g., by scripting).

Configuration drift refers to a divergence over time between an intended and/or defined configuration and an actual configuration that exists in a system and/or environment. For example, if configuration changes are applied manually outside of an IaC workflow to a running resource, the actual resource configuration may diverge from the configuration defined in code, resulting in discrepancies between the defined versus actual configuration. As another example, if an IaC code definition is updated but the corresponding changes are not fully applied to existing provisioned resources, the provisioned resources may continue operating with outdated settings, and exhibit configuration drift relative to the intended configuration. As a further example, if automated systems, patches, and/or scaling mechanisms modify resource attributes dynamically without updating the associated IaC state and/or code definitions, those resources may no longer reflect the declared configuration, which may lead to configuration drift.

Cloud assets refer to resources provisioned, configured, and/or managed within a cloud computing environment. Cloud assets may span multiple cloud service providers and may include managed and/or unmanaged resources, as well as infrastructure instantiated via Infrastructure as Code (IaC) or through other provisioning mechanisms. Some non-limiting examples of cloud assets include compute resources (e.g., virtual machines, containers, and/or container clusters), serverless resources (e.g., functions, managed execution services), storage resources (e.g., storage buckets, volumes, file systems, and/or snapshots), networking resources (e.g., virtual networks, load balancers, gateways, and/or security groups), data resources (e.g., databases, caches, message queues, and/or data stores), and/or identity and access resources (e.g., user roles, IAM policies, service accounts, and/or API keys).

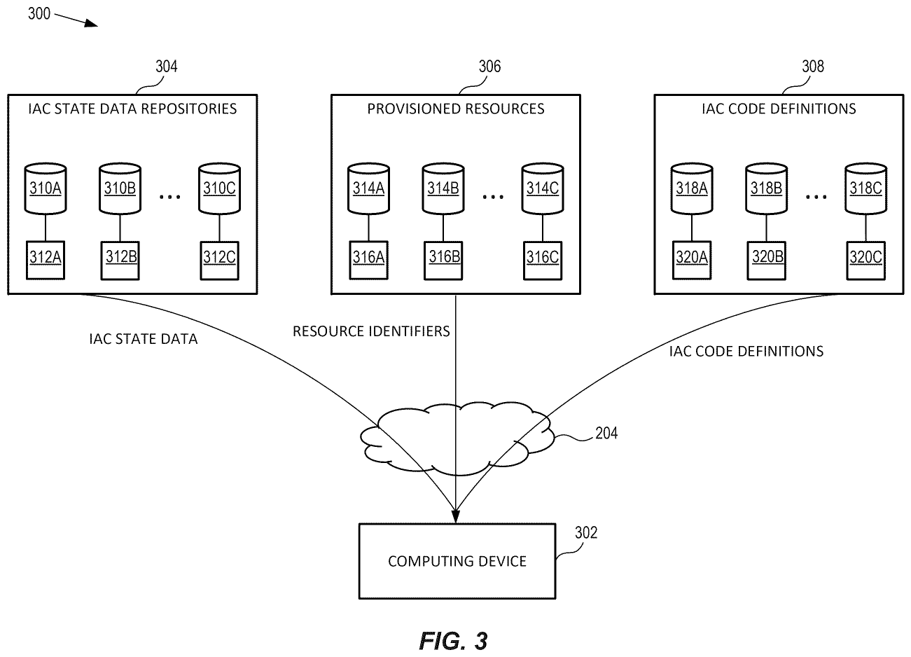

Reference is made to FIG. 3, which is an exemplary schematic diagram of a system 300 for identifying IaC associated with cloud assets, consistent with some disclosed embodiments. System 300 may include at least one computing device 302 (e.g., corresponding to computing device 200 in FIG. 2, the computing device including at least one processor 102 in FIG. 1). System 300 may also include a collection of IaC state data 304, a collection of provisioned resources 306, and a collection of IaC code repositories 308. Collection of IaC state data 304 may include a plurality of distributed, heterogeneous IaC state data repositories 310A-310C associated with a plurality of differing computing devices (e.g., servers) 312A-312C. Collection of provisioned resources 306 may include a plurality of distributed data repositories 314A-314C, each associated with a differing computing device (e.g., server) 316A-316C. Similarly, collection of IaC code repositories 308 may include a plurality of distributed, heterogeneous data repositories 318A-318C storing IaC code definitions in association with a plurality of differing computing devices (e.g., servers) 320A-320C. At least one computing device 302 may establish a plurality of communication channels with each data repository and/or associated computing device included in IaC state data 304, provisioned resources 306, and/or IaC code repositories 308 via network 204.

Some disclosed embodiments involve locating IaC state data. To locate refers to identify, discover, and/or determine the existence, identity, and/or retrievable reference. Locating may include determining a reference for retrieving a cloud resource and/or related data within a cloud environment. Locating may include determining sufficient information to access, correlate, and/or operate on the cloud resource. IaC state data refers to data representing a recorded status and/or condition of infrastructure resources provisioned and/or managed using IaC. IaC state data may include information that reflects a current and/or last-known configuration of resources deployed in a cloud or computing environment, data for tracking cloud infrastructure resources, and/or release information for an application automating container workload orchestration (e.g., Kubernetes®). IaC state data may be distributed across multiple heterogenous state backend storage repositories. It may be stored concurrently in multiple buckets and/or via a plurality of different remote services (e.g., Terraform®, Pulumi®, and/or Helm®). Each IaC tool (i.e., a software application for implementing Infrastructure-as-Code) may maintain a respective repository for state data using a proprietary storage model. For instance, for a given application, one IaC service may store state data mapping resources to real-world cloud resources in a first cloud storage bucket, another IaC service may maintain a state for each stack (i.e., deployment instance) in a second cloud storage bucket, and an additional IaC service may maintain release information for an automated workload application within an orchestration platform (e.g., in a third persistent storage location). In some embodiments, IaC state data may include associated metadata, such as an author, manager, and/or owner, a timestamp and/or date indicating time of creation and/or last update, one or more associated locations, scopes, use-cases, resources, and/or any other type of metadata.

In some disclosed embodiments, IaC state data may include at least one of Terraform state data, Helm state data, Pulumi state data, or CloudFormation stack state data. In general, IaC state data may be stored in a cloud storage bucket. A cloud storage bucket refers to a logical container for storing and/or organizing data objects, along with associated metadata and/or access controls. A cloud storage bucket may be provided by a cloud object-storage service within a cloud provider's infrastructure. IaC state data including a cloud storage bucket may include an identifier, address, and/or additional associated information for accessing the cloud storage bucket.

Terraform state data refers to persistent data (e.g., maintained by Terraform®) that records a current state of managed infrastructure by mapping declared Terraform resources to their corresponding real-world cloud resources, including resource identifiers, attributes, and dependencies. Terraform state data may be used to map Terraform IaC code definitions with provisioned cloud resources, detect drift between declared infrastructure versus deployed infrastructure, and/or plan updates, replacements, deletions, and/or creations of deployed infrastructure. Terraform state data may be stored in an associated backend repository (e.g., a proprietary cloud storage bucket), and may exist in multiple locations in association with a plurality of workspaces, environments, and/or teams.

Helm state data refers to persistent release information (e.g., maintained by Helm®) that records the configuration, revision history, and/or deployment status of a Helm chart instance (release). Helm state data may be stored as Kubernetes resources such as Secrets or ConfigMaps within a Kubernetes cluster.

A Pulumi state data refers to persistent metadata (e.g., maintained by Pulumi®) recording a current state of managed infrastructure by mapping declared resources to their corresponding real-world cloud resources, including resource identifiers, properties, and/or dependencies. A Pulumi state may be stored for a particular stack or deployment instance in a configurable state backend. It may be maintained in a state file containing descriptions for resources (e.g., Virtual Private Clouds, databases, Kubernetes clusters), provider-specific identifiers, input properties used to create cloud resources, output properties returned from a cloud provider, dependency relationships between other resources, and/or metadata about a particular stack. A Pulumi state may be used to determine drift by comparing declared code with actual deployed infrastructure, plan updates by computing which resources need to be created, updated, replaced, and/or deleted, track dependencies, and/or enable rollbacks and previews.

A stack refers a logical collection of cloud resources defined in an Infrastructure-as-Code template and managed as a single unit, such that creating, updating, and/or deleting a stack causes a cloud platform to provision, modify, and/or remove associated resources together as a single unit. CloudFormation® stack state data refers to an authoritative, runtime record of an application's infrastructure as deployed from one or more Infrastructure-as-Code (IaC) templates. It may include stack identifiers, current and historical stack statuses, parameters, outputs, tags, and/or resolved resource identifiers generated from logical template definitions. State stack data may reflect a reconciliation of a declared template with a provisioned resources and may be continuously updated as stacks are created, updated, and/or rolled back. By persisting and analyzing stack state data, at least one processor may correlate discovered cloud assets (e.g., EC2 instances, load balancers, IAM roles) to their originating IaC definitions, enabling traceability, and/or detection of configuration drift based on a current view of resources by a service provider.

Since IaC state data may be distributed and stored concurrently across multiple buckets and/or platforms, to locate IaC state data, at least one processor may discover, identify, and/or access a plurality of heterogeneous state records stored across multiple backends and/or services. Locating IaC state data may require discovery, inference, and/or heuristics. The location process may rely on state backends, metadata correlation, deterministic or probabilistic lookup techniques, and/or any other method for locating IaC state data. At least one processor may locate IaC state data by discovering state records across multiple heterogeneous state backends using configured backend descriptors, metadata-based correlation with provisioned resources, contextual analysis of workspaces and deployments, dependency analysis, event record inspection, heuristic or confidence-based matching, and/or any other technique for locating state data, to identify distributed IaC state data maintained by different services. For instance, at least one processor may locate IaC state data using a configured state backend descriptor (e.g., identifiers, addresses and/or references) indicating identifiable cloud storage buckets from where IaC state data may be retrieved. As another example (e.g., if locations for IaC state data are not explicitly known), at least one processor may access provisioned cloud resources, extract resource identifiers, and match the identifiers to identifiers stored in state records. As another example, at least one processor may use contextual cues (e.g., workspace identifiers, environment, deployment, and/or stack context) to locate IaC state data. As another example, at least one processor may analyze event logs to identify references to state files, backend storage, stacks, and/or releases and use those references to locate IaC state data. As a further example, at least one processor may use one or more heuristics and/or probabilistic confidence matching techniques to locate IaC state data, e.g., under incomplete information. Thus, at least one processor may collect state records from multiple sources at multiple locations using a plurality of techniques. At least one processor may aggregate the collected state records, e.g., by cross referencing and/or cross correlating state records retrieved from differing sources.

Some disclosed embodiments involve analyzing the IaC state data to identify attributes of associated provisioned resources. Attributes refers to characteristics, features, qualities, and/or traits. Provisioned resources refers to resources that have been instantiated, configured, deployed and/or activated, for example, using infrastructure-as-code definitions, in a computing environment as a result of applying a provisioning process. Provisioned resources may include cloud resources whose existence and configuration are reflected in corresponding state data. Provisioning of resources may occur when infrastructure definitions are applied and result in the creation and/or modification of cloud assets. Data (e.g., identifiers, attributes, and/or configuration details) associated with provisioned resources may be recorded as IaC state data. Provisioned resources may later be correlated back to an executable code associated with the creation and/or governing of the resources.

To analyze data refers to examining, investigating, organizing, and/or interpreting data to extract insights, identify patterns, and/or support decision-making. Analyzing may additionally or alternatively involve determining and/or applying mathematical or statistical algorithms and/or correlations between data sets, identifying patterns and/or features (e.g., using artificial intelligence). After IaC state data is retrieved from multiple heterogeneous sources and storage locations, at least one processor may analyze the IaC state data by parsing state records maintained in different formats and/or storage models into a common representation and examining the contents of the state records to identify attributes of associated provisioned resources. Such analysis may include extracting identifying attributes recorded in the state data, such as resource identifiers, resource names, resource types, cloud provider identifiers, account or subscription identifiers, project identifiers, and/or region information, as well as IaC-specific attributes such as resource addresses, module paths or hierarchy, stack, workspace, and/or environment identifiers, and/or state file or version identifiers. At least one processor may identify configuration and/or declarative attributes reflected in the state data, including instance size, storage configuration, network settings, security or encryption parameters, and/or availability and/or scaling characteristics, along with lifecycle and provenance attributes such as creation time, last modification time, last applied IaC operation, and/or state version. At least one processor may analyze lifecycle and provenance information recorded in the state data, including provisioning timestamps, creation and last modification times, state version numbers, and indications of the last applied IaC operation, thereby enabling tracking of resource evolution over time. At least one processor may analyze dependency and relationship information recorded in the IaC state data, including parent-child relationships, explicit or implicit dependencies, and shared module, stack, and/or deployment identifiers, and may compare attributes across multiple state records to correlate related resources managed by different IaC services. Through this analysis, at least one processor may identify configuration drift-related attributes, such as differences between declared and recorded configurations, compliance indicators, and orphaned or unmanaged resources, thereby enabling consistent identification of attributes of provisioned resources without relying on manually introduced tags.

In some disclosed embodiments, the identified attributes include at least one of a resource name, a resource type, a resource identifier, or a module chain. A resource name refers to an identifier assigned to a specific instance of a computing and/or cloud resource. A resource name may enable a resource to be uniquely identified, referenced, and/or managed within a defined scope, such as an account, project, and/or resource group. Some non-limiting examples of resource names include a virtual machine name, a cloud storage bucket name, a managed database name, a container cluster name, and a load balancer name, each serving as a human-readable and system-recognizable identifier for the corresponding resource. A resource type refers to a classification that defines the kind of functionality and/or capabilities provided by a resource. A resource type may specify how a resource is created, configured, and/or managed within a computing and/or cloud environment. Some non-limiting examples of resource types include a virtual machine type for compute instances, a storage bucket type for object storage, a database instance type for managed data services, a virtual network type for connectivity and isolation, a load balancer type for traffic distribution, and an identity role type for access control, each representing a distinct category of manageable resources. A module chain refers to an ordered and/or hierarchical sequence of interconnected infrastructure and/or software modules in which one module consumes outputs and/or depends on configurations produced by another module. A module chain may enable composition and/or reuse of functionality across a system. Some non-limiting examples of a module chain include a network module that provides subnet identifiers to a compute module, which in turn supplies instance endpoints to a load-balancing module, a foundational identity module that feeds access roles into an application deployment module, and a storage module whose outputs are referenced by a data-processing module, with each module linked through explicit inputs and outputs to form a dependency chain.

Some non-limiting examples of attributes for provisioned resources may include attributes, such as resource identifiers, resource names (e.g., as declared in an IaC file), resource types (e.g., machine instance, storage bucket, IAM role), cloud provider identifier, account, subscription, and/or project identifiers, and/or region. Some additional attributes for provisioned resources may include IaC state attributes, such as IaC resource addresses, module paths and/or hierarchy, state file identifier, workspace and/or environment name, IaC alias and/or version. Some additional attributes for provisioned resources may include configuration and/or declarative attributes, such as instance size or flavor, disk size or type, network configuration, encryption settings, autoscaling parameters, and/or availability or redundancy flags. Attributes for provisioned resources may further include IaC generated metadata and/or tagging attributes, such as deployment identifiers, stack name, module name, provisioning timestamp. Attributes for provisioned resources may further include lifecycle and/or provenance attributes, such as creation timestamp, last modified timestamp, last applied IaC operation, and/or state version number. Attributes for provisioned resources may additionally include dependency and/or relationship attributes, such as parent-child relationships to other resources, explicit dependencies, shared module identifiers, and/or shared deployment or stack identifiers. Attributes for provisioned resources may further include drift and compliance attributes, such as declared values vs actual values, drift status, compliance state, and/or orphaned resource indicators. For instance, at least one processor may analyze state data for a provisioned virtual machine and identify attributes such as a resource ID, resource type, a region, an address for IaC code, a state file identifier, an instance type, a subnet identifier, a security group identifier, one or more tags, a creation timestamp, and/or a flag indicating if the virtual machine is managed by an IaC code definition.

In some disclosed embodiments, provisioned resources include at least one of cloud resources, managed resources, managed computing infrastructure resources, or on-premise resources. A cloud resource refers to a virtualized computing component provided and/or managed by a cloud service provider that delivers functionality, capacity, and/or services over a network. Examples of cloud resources may include virtual machines used to run applications, cloud storage buckets for storing objects and data, managed databases for structured data persistence, virtual networks and subnets for connectivity, load balancers for traffic distribution, identity and/or access roles for security control, container clusters for orchestrating workloads, and/or serverless functions for executing code on demand. A managed resource refers to a computing and/or service component whose provisioning, operation, scaling, maintenance, and underlying infrastructure are handled wholly and/or primarily by a service provider rather than by a customer. Examples of managed resources may include databases where a provider handles backups and/or patching, Kubernetes services where a provider handles maintenance, security, and/or scaling, managed message queues for asynchronous communication, managed identity services for authentication and access control, managed load balancers for traffic distribution, and/or deployed application code where a provider handles maintenance, server provisioning, updates, and/or scaling.

A managed computing infrastructure resource refers to a component whose underlying hardware, availability, scaling, patching, and/or operational management are handled by a service provider, while a consumer may configure and/or use the resource via a higher-level interface. Examples of managed computing infrastructure resources may include managed virtual machines where a provider maintains host systems, managed container platforms, managed serverless compute services that execute code without user-managed servers, managed batch-processing environments for scheduled workloads, and/or managed virtual desktop infrastructures delivered as an on-demand service. An on-premise resource refers to a computing, storage, and/or networking component that may be physically located within, owned, and/or controlled by an organization's facilities rather than by a cloud service provider. Examples of on-premise resources include physical servers running enterprise applications, local storage arrays and network-attached storage systems, on-site networking equipment such as routers and/or firewalls, private virtualization platforms hosting virtual machines, and internally managed databases and/or application servers deployed within a corporate data center.

In some disclosed embodiments, at least some of provisioned resources are associated with differing cloud service providers. A cloud service provider refers to an entity that delivers on-demand computing services over the internet without requiring customers to own or manage the underlying physical infrastructure. Such computing services may include compute power, storage, networking, platforms, software, and/or any other type of computing service. Examples of cloud service providers include Amazon Web Services® (AWS), Microsoft Azure®, Google Cloud Platform® (GCP), Oracle Cloud Infrastructure®, and IBM Cloud®, each offering scalable infrastructure, platform, and software-based services to organizations and/or developers.

In some disclosed embodiments, IaC state data lacks manually introduced tags. A tag refers to a label, annotation, and/or metadata. A tag may be added to a piece of data to incorporate additional information included in the tag. For example, a tag may be added to an identifier for a resource to permit identifying, classifying, correlating, and/or managing the resource. For instance, a tag may include ownership information such as a team name, department, cost center, or responsible individual; environment identifiers indicating whether a resource is associated with a development, testing, staging, or production environment; application and/or service identifiers identifying an application, workload, and/or service to which the resource belongs; geographic and/or regional information such as a data center location, cloud region, and/or availability zone; lifecycle and/or status metadata including version information, deployment state, and/or operational status; security and/or compliance classifications such as sensitivity level, regulatory category, and/or access control designation; temporal metadata such as a creation date, expiration date, and/or last-updated indicator; billing and/or cost-tracking information including project identifiers and/or budget codes; and/or operational attributes such as performance tier, scaling policy, and/or redundancy level.

Lacking refers to missing, absent, and/or otherwise unavailable and/or inaccessible. Lacking manually introduced tags refers to exclusion, and/or absence of user-applied labels, annotations, and/or metadata created and/or assigned by human action, while permitting system-generated identifiers, state records, and/or automatically derived metadata to facilitate resource identification and/or correlation. IaC state data lacking manually introduced tags may include tags automatically generated by a cloud service provider, an automated agent (e.g., an AI agent), an infrastructure-as-code tool, and/or any other type of computer-generated tag.

Some disclosed embodiments involve accessing provisioned resources. Accessing refers to retrieving information from, and/or interacting with a resource (e.g., data, services, functionality, etc.). Accessing may include gaining a capability for interacting with and/or making use of the resource, such as by gaining admittance and/or permission to read and/or otherwise make use of a resource. For example, at least one processor may access provisioned resources by establishing communication with one or more cloud providers, for instance using an application programming interface (API). The at least one processor may identify and/or query provisioned resources based on resource identifiers, account or subscription context, region, and/or resource type, and obtain current state information describing the provisioned resources.

After IaC state data is retrieved and analyzed, at least one processor may access provisioned resources using identifying attributes extracted from the IaC state data, such as resource identifiers, resource types, cloud provider identifiers, account or subscription context, and/or region information. However, provisioned resources may reside across multiple cloud service providers, accounts, subscriptions, projects, and/or environments. At least one processor may thus establish authenticated communication with multiple corresponding cloud provider interfaces to access the provisioned resources. In some embodiments, at least one processor may query cloud environments to obtain current state information for a provisioned resource and encounter discrepancies between the state information and an identified resource, missing resources, renamed or replaced resources, and/or partial deployments due to configuration drift. Accordingly, to access provisioned resources, instead of using a direct one-to-one correspondence between state records and deployed resources, at least one processor may account for ambiguity, drift, and/or multi-resource relationships reflected in the IaC state data. For instance, at least one processor may analyze attributes extracted from the IaC state data (e.g., resource identifiers, resource types, naming conventions, module chains, workspace or environment context, and/or cloud account or region information) to query a cloud environment for current resource information. Where discrepancies are encountered, such as missing, renamed, replaced, and/or partially deployed resources resulting from drift, a processor may correlate state records with one or more candidate resources by matching shared and/or derived attributes.

In addition, when a single record of the IaC state date corresponds to multiple resource instances or where multiple state records correspond to a single provisioned resource, at least one processor may query a cloud environment using combinations of attributes extracted from the IaC state data, such as resource identifiers, resource types, naming patterns, module chains, account or subscription context, and/or region information. A processor may retrieve information for multiple candidate resources potentially associated with the IaC state data to access provisioned resources while accounting for ambiguity, configuration drift, and one-to-many or many-to-one relationships reflected in the IaC state data, without assuming a single deterministic correspondence.

By way of a non-limiting example, in FIG. 3, at least one processor (e.g., processor 102 of FIG. 1 included in computing device 302) may locate IaC state data 304 by locating one or more distributed, heterogeneous IaC state data repositories 310A-310C and/or plurality of associated computing devices 312A-312C via network 204. In some embodiments, IaC state data repositories 310A-310C may include at least one of a cloud storage bucket, version control metadata, Terraform state data, Helm state data, and/or Pulumi state data. At least one processor may retrieve IaC state data stored in any of repositories 310A-310C by communicating with associated computing devices 312A-312C via network 204. Data stored in and/or retrieved from IaC state data 304 may lack manually introduced tags. At least one processor may analyze the IAC state data to identify attributes of associated provisioned resources 306. At least one processor may access provisioned resources 306, e.g., by communicating with computing devices 316A-316C and/or associated data repositories 314A-314C via network 204 using the identified attributes. At least one processor may obtain identifiers (e.g., locators, network addresses, unique resource IDs, logical names, and/or any other type of identifier) for each of the provisioned resources included in collection of provisioned resources 306.

In some embodiments, the identified attributes may include at least one of a resource name, a resource type, a resource identifier, and/or a module chain. In some embodiments, provisioned resources 306, including distributed data repositories 314A-314C and associated computing devices 316A-316C, may include at least one of cloud resources, managed resources, managed computing infrastructure resources, and/or on-premise resources. In some embodiments, at least some of provisioned resources 306 may be associated with differing cloud service providers. For instance, data repository 314A associated with computing device 316A may be associated with a first cloud service provider, data repository 314B associated with computing device 316B may be associated with a second cloud service provider, and data repository 314C associated with computing device 316C may be associated with a third cloud service provider.

Some disclosed embodiments involve establishing a first map between IAC state data and provisioned resources based on identified attributes. Establishing refers to setting up, creating, initiating, and/or instituting. A map refers to a data structure, association, correspondence, and/or representation defining a relationship between two sets of entities. A map may link corresponding elements of two or more sets based on one or more shared and/or derived attributes. A map may include a lookup table, a graph, an array, an association list, a dictionary, and/or any other type of data structure associating and/or coupling two sets of entities. Establishing a first map between the IaC state data and the provisioned resources based on the identified attributes may include defining a correspondence between a recorded status for provisioned resources and actual resources existing in a computing environment based on common characteristics. It may include creating an association that links IaC state data entries to identifiers and/or locators for actual deployed cloud resources by matching one or more shared attributes included in the IaC state data and in the definitions for the provisioned resources. For instance, after analyzing the IaC state data to extract attributes (e.g., resource identifiers, locators, links, addresses, names, types, and/or module chains), at least one processor may use at least some of the attributes to correlate state records with corresponding provisioned resources that exist in the cloud environment. At least one processor may apply the correlation to produce a map linking resources that exist based on the IaC state data with actually deployed resources (e.g., by linking associated identifiers, locators, and/or any other identifying data), without relying on manual tagging. For example, at least one processor may deterministically associate a resource referred to in the IaC state data with a deployed resource based on a resource identifier assigned by a service provider. As another example, at least one processor may correlate a live resource to its declarative definition using a logical IaC address and deployment context, even when provider identifiers differ. As a further example, at least one processor may correlate resources provisioned via IaC using propagated tags and/or labels when deterministic identifiers are unavailable.

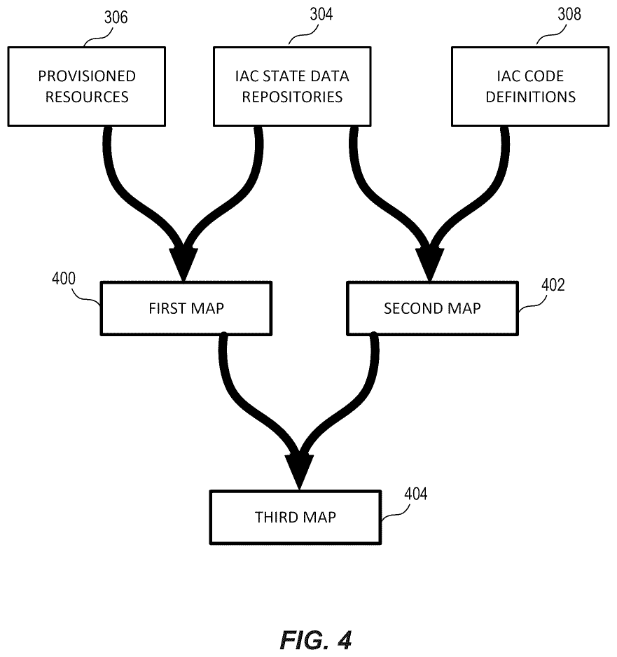

By way of a non-limiting example, reference is made to FIG. 4, which is an exemplary schematic diagram of a plurality of maps for identifying IaC associated with cloud assets, consistent with some disclosed embodiments. Based on the identified attributes of provisioned resources 306, at least one processor (e.g., included in computing device 302 in FIG. 3) may establish a first map 400 between IaC state data 304 and provisioned resources 306. For instance, IaC state data retrieved from IaC state data repositories 310A-310C may contain identifiers for at least some of computing devices 316A-316C and/or associated data repositories 314A-314C included in provisioned resources 306. At least one processor may extract the identifiers from the retrieved IaC state data, correlate the extracted identifiers with identifiers included in resource attributes obtained directly by accessing computing devices 316A-316C and/or associated data repositories 314A-314C contained in provisioned resources 306, and include the correlations in the first map 400. Additionally or alternatively, at least one processor may apply one or more heuristics and/or inferences to correlate attributes and/or identifiers for computing devices 316A-316C and/or associated data repositories 314A-314C included in provisioned resources 306 with attributes contained in the retrieved IaC state data (e.g., using an AI engine), and include the inferred correlations in first map 400.

Some disclosed embodiments involve accessing a set of IAC code definitions. A set refers to a collection and/or group of items. A set may include a suite of items associated with a common characteristic and/or purpose. IAC code definitions refers to machine-readable configuration artifacts (i.e., computer generated outputs) that specify a desired state of computing infrastructure. IaC code definitions may enable infrastructure resources to be provisioned, configured, modified, and/or reproduced automatically by one or more processors, rather than through manual operations. IaC code definitions may describe infrastructure elements (e.g., compute, storage, networking, and/or access controls) in code form, enabling consistent deployment and/or management of the infrastructure elements across differing computing environments and/or phases (e.g., development, staging, and production).

An IAC code definition may declare what infrastructure should exist without specifying procedural steps for producing the infrastructure (i.e., Declarative to achieve a desired state). For example, an IaC code definition may state “create three web servers, attach them to a load balancer, allow HTTPS traffic, and provision a database with daily backups,” expressing a target infrastructure state. At least one processor (e.g., associated with an IaC engine) may compare the IaC code definition against a current infrastructure state and take actions to reconcile any discrepancies automatically to achieve consistency and reproducibility. As another example, a declarative IaC code definition may formulate specifications for network and security resources, such as virtual networks and subnets, firewalls and security groups, load balancers and gateways, and identity and access control policies, as code, permitting at least on processor to reliably instantiate the same security posture across multiple cloud environments without incurring manual configuration drift. As an additional example, a declarative IaC code definition may include a reusable template and/or module (e.g., a Terraform module, or a cloud template) that may act as a blueprint for provisioning multiple related resources. For instance, a single template may define a standardized application stack (e.g., compute, networking, storage, and permissions) that may be instantiated repeatedly for different teams and/or environments while maintaining uniform configuration and governance.

Additionally or alternatively, an IaC code definition may be imperative, and include procedural instructions defining how to achieve a desired state, step-by-step. For example, using Ansible®, a “playbook” may define a sequence of tasks to execute on target machines. For instance, a playbook may first install a package, then create a configuration file, and then initiate a service. The order of operations may be defined as an IaC code definition, and the tool may execute the operations steps procedurally. As another example, using Chef®, a “recipe” may describe specific actions such as installing software, modifying files, and/or enabling services. The recipe may outline the steps to be taken, and at least one processor may execute the steps in the defined order to reach the intended configuration. As a further example, Puppet® may incorporate imperative-style logic (e.g., conditional statements, execution resources, ordering constraints) defining how resources (e.g., packages, services, files) are to be configured and managed during execution. In some embodiments, IaC code definitions may include associated metadata, such as an author, manager, and/or owner of an IaC code definition, a timestamp and/or date indicate time of creation and/or last update, one or more associated locations, scopes, use-cases, resources, and/or any other type of metadata.

Accessing refers to retrieving, involving, or interacting with a resource (e.g., data, services, functionality, etc.). Accessing may refer to a capability for interacting with and/or making use of the resource. Infrastructure-as-code definitions may be stored in one or more repositories, template libraries, and/or chart repositories, such as Git® repositories containing Terraform modules, Pulumi programs, infrastructure templates, and/or Helm charts. At least one processor may access infrastructure-as-code (IaC) code definitions by identifying one or more repositories and/or template sources associated with a computing environment and retrieve IaC artifacts stored therein, such as modules, templates, programs, and/or charts. In some embodiments, at least one processor may access version-controlled repositories (e.g., source code repositories) using repository identifiers, addresses, credentials, and/or configuration metadata, and may retrieve IaC files corresponding to one or more branches, versions, and/or deployment contexts. At least one processor may parse the retrieved IaC code definitions to extract declared resource names, resource types, module or template structure, and/or other attributes, such as version control metadata, authorship and/or ownership, for provenance and/or context. In instances where multiple IaC repositories are accessible, at least one processor may analyze and group IaC code definitions based on similarity, usage patterns, or deployment context, and correlate attributes extracted from the IaC code definitions with attributes identified from IaC state data to determine which IaC code definitions are associated with particular provisioned resources, without using or requiring manually introduced tags.

In some disclosed embodiments, a set of IaC code definitions includes at least one of a Pulumi program, a Terraform module, a CloudFormation template, an ARM template, a Bicep template, or a Helm chart. A Pulumi® program refers to a set of executable instructions for declaring, configuring, and/or managing cloud infrastructure resources. A Pulumi program may express a state for a desired infrastructure resource as code. At least one processor may evaluate a Pulumi program to provision and/or track infrastructure resources. A Terraform module refers to a reusable, self-contained collection of configuration files that groups related infrastructure resources into a single logical unit that may be invoked by other configurations. Some non-limiting examples of Terraform modules include a network module that provisions a virtual private cloud and subnets, a compute module that deploys one or more virtual machine instances, a Kubernetes module that creates and configures a managed cluster, a database module that provisions a managed database service, and an identity module that defines roles and permissions, each encapsulating a specific infrastructure function for reuse and composition. A template refers to a structured file and/or blueprint that defines a set of components, configurations, and/or resources in a reusable and repeatable format, enabling automated creation and/or management of systems based on the defined structure. A CloudFormation template refers to a text file (e.g., written in JSON or YAML) that defines a collection of resources and their configurations for automated provisioning, updating, and/or deletion. Some non-limiting examples of CloudFormation templates include a template that provisions a virtual network, a template that launches and configures one or more virtual machine instances, a template that creates a cloud storage bucket, a template that deploys a managed database service, and a template that defines an application stack with load balancers, compute resources, and security roles. An Azure Resource Manager® (ARM) template refers to a file (e.g., written in JSON) for defining and/or deploying resources and their configurations as a single, repeatable deployment. Some non-limiting examples of ARM templates include a template that provisions a virtual network with subnets and network security groups, a template that deploys one or more virtual machines with associated storage and networking, a template that creates a storage account with access policies, a template that deploys a managed database service, and a template that defines an application environment. A Bicep template refers to an Infrastructure-as-Code file written in the Bicep domain-specific language that defines resources and their configurations in human-readable syntax and compiled for deployment. Some non-limiting examples of Bicep templates include a template that provisions a virtual network, deploys virtual machines, creates a storage account, deploys a managed database service, and/or defines an application environment using Bicep modules. A Helm® chart refers to a packaged collection of files that defines, configures, and/or deploys a related set of resources as a reusable and versioned unit. Some non-limiting examples of Helm charts include a chart that deploys an application, installs a web application stack, deploys a database, and/or installs a monitoring system.

In some disclosed embodiments, a set of IaC code definitions includes a plurality of reusable blueprints for provisioning a plurality of resources. Provisioning a plurality of resources refers to creating, allocating, and/or making a computing resource available for use. Provisioning a resource may include instantiating the resource, assigning and/or allocating required infrastructure components and/or services, establishing an initial operational state so that the resource may be managed and/or used as intended, and/or any other operation needed to make a computing resource available for use. A reusable blueprint refers to a template and/or general specification describing how something may be structured, created, updated, and/or maintained, and that may be used repeatedly to produce consistent results. For instance, each deployed infrastructure resource may be created from the same defined, reusable specification or template that consistently describes how the resource should be provisioned and/or configured. A plurality of reusable blueprints for provisioning a plurality of resources refers to a set of predefined, reusable specifications that each define how a corresponding resource is to be provisioned and/or configured. Each reusable blueprint may be instantiated one or more times to create individual resource instances in a consistent and repeatable manner, enabling standardized provisioning of resources across multiple environments and/or deployments.

In some disclosed embodiments, each provisioned resource corresponds to a single reusable blueprint. In other words, every resource that is created may be derived from one defined, reusable specification that governs how the resource is provisioned. Consequently, each resource instance may be traced back to exactly one blueprint that consistently defines its structure, configuration, and provisioning behavior. Some non-limiting examples of provisioned resources corresponding to a single reusable blueprint include a virtual machine instance created from a single Terraform module reused across environments, a cloud storage bucket provisioned from a standardized CloudFormation or ARM template, a Kubernetes deployment instantiated from a specific Helm chart, a managed database created from a reusable infrastructure template, and a serverless function deployed from a common blueprint that defines its runtime, permissions, and configuration, with each resource instance tracing back to one reusable definition.

In some disclosed embodiments, IaC code definitions may include version control metadata. A version refers to an edition, a revision, variation, and/or variant. For instance, a file may be have multiple versions corresponding to successive updates. Version control refers to the practice of tracking, managing, and/or recording changes to files over time so that specific versions may be identified, reviewed, and/or restored as needed. Version control metadata refers to recorded information describing a history, context, and/or authorship of changes to managed files, such as commit identifiers identifying specific sets of changes, authors, timestamps, branch names, and/or change descriptions.

By way of a non-limiting example, in FIG. 3, at least one processor (e.g., processor 102 in FIG. 1 included in computing device 302) may access IaC code definitions 308, e.g., by accessing plurality of distributed, heterogeneous data repositories 318A-318C via computing devices 320A-320C over network 204. At least one processor may retrieve IaC code definitions stored in data repositories 318A-318C. In some embodiments, the set of IaC code definitions includes at least one of a Pulumi state, a Terraform module, a CloudFormation template, an ARM template, a Bicep template, or a Helm chart. In some embodiments, the set of IaC code definitions includes a plurality of reusable blueprints for provisioning plurality of resources 306. In some embodiments, each provisioned resource included in plurality of resources 306 corresponds to a single reusable blueprint.

Some disclosed embodiments involve establishing a second map between IAC state data and a set of IAC code definitions. Establishing a second map between IAC state data and a set of IAC code definitions may include defining a correspondence between a recorded status for currently provisioned resources and a set of machine-readable specifications defining a desired state of computing infrastructure. It may include creating an association that links IaC state data entries for existing infrastructure to a list of desired and/or required infrastructure specified as executable code. It may include analyzing infrastructure-as-code (IaC) state data and correlating the state data to specific IaC code definitions (e.g., templates, modules, and/or configuration files) for generating and/or governing the provisioned resources reflected in the IaC state data. Establishment of the second map may be independent of actual cloud resources and may enable identifying which IaC code definitions correspond to which portions of the recorded state data for the provisioned resources. The second map may be established even when the state data lacks manually introduced tags or explicit references to the IaC source code. The second map may thus link recorded infrastructure state data to its originating IaC code definitions. The second map may be subsequently combined with the first map to trace code defining provisioned resources to the provisioned resources.

For example, at least one processor may access Terraform state data and analyze attributes such as resource identifiers, module paths, and/or logical names. Based on this analysis, at least one processor may establish a second map that associates portions of the Terraform state data with corresponding modules or configuration files included in a source code repository, to identify which IaC code definitions produced the recorded state entries. As another example, IaC state data may include references to multiple provisioned resources instantiated from a reusable IaC template. By examining attributes in the state data, at least one processor may establish a second map linking the state data to the specific IaC code template that defines the reusable blueprint. As a further example, where IaC state data lacks manually introduced tags, at least one processor may analyze inherent attributes within the state data, such as resource types, naming conventions, and/or module chains, to establish a second map correlating the state data to the originating IaC code definitions without relying on external annotations and/or manually introduced tags.

By way of a non-limiting example, in FIG. 4, at least one processor (e.g., processor 102 in FIG. 1 included in computing device 302 in FIG. 3) may establish a second map 402 between IaC state data 304 and the set of IaC code definitions 308. For instance, at least one processor may correlate resource identifiers extracted from the retrieved IaC state data for currently provisioned resources with resource identifiers extracted from the retrieved IaC code definitions, thereby mapping identifiers for existing infrastructure, based on IaC state data, to definitions for those resources as specified in executable IaC code.

Some disclosed embodiments involve, based on the first map and the second map, establishing a third map between the set of IAC code definitions and the provisioned resources. Based on the first map and the second map refers to derived from, determined from, and/or dependent on the first map and the second map. Establishing a third map between a set of IaC code definitions and provisioned resources refers to deriving a direct association between specific infrastructure-as-code (IaC) code definitions and the actual provisioned resources. The third map may be established by combining the first map, which links IaC state data to provisioned resources, and the second map, which links the same IaC state data to the IaC code definitions. At least one processor may join two intermediary relationships through shared IaC state data, expressed by the first map and the second map, to establish a third map that directly maps each IaC code definition to one or more provisioned resources created, configured, and/or governed by the associated definition.

Some disclosed embodiments involve mapping the set of IAC code definitions to the provisioned resources without requiring manual tagging of the provisioned resources. The may refer to deriving a direct association between specific infrastructure-as-code (IaC) code definitions and actually provisioned resources by combining a first map linking IaC state data to provisioned resources, and a second map linking the same IaC state data to IaC code definitions. At least one processor may join two relationships through shared IaC state data to directly map each IaC code definition to one or more provisioned resources created, configured, or governed by the definition. The third map may enable end-to-end traceability from code to deployed infrastructure without requiring manually introduced tags or labels on the provisioned resources. The third map may thus support functions such as ownership tracing, security incident analysis, drift detection, and/or governance by identifying which code definitions correspond to which live resources.

By way of a non-limiting example, in FIG. 4, at least one processor (e.g., processor 102 in FIG. 1 included in computing device 302 in FIG. 3) may establish a third map 404 between IAC code definitions 308 and provisioned resources 306 based on first map 400 and second map 402. At least one processor may thereby map IAC code definitions 308 to provisioned resources 306 without requiring manual tagging of the provisioned resources.

Some disclosed embodiments involve applying at least one heuristic to disambiguate among multiple candidate matches between at least the IAC state data and the provisioned resources, the IAC state data and the set of IAC code definitions, or the set of IAC code definitions and the provisioned resources to thereby establish at least one of the first map, the second map, or the third map To disambiguate refers to removing and/or resolving uncertainty, doubt, imprecision, and/or ambiguity. To disambiguate may include clarifying which meaning, interpretation, and/or reference may be applied in a particular context. For instance, disambiguating may include providing additional context and/or distinguishing information to break a tie. A heuristic refers to a general, experience-based rule and/or technique for making a practical determination and/or approximation when an exact and/or exhaustive analysis is unnecessary and/or impractical. For example, a heuristic may provide a flexible way to infer whether different data sets and/or resources correspond to one another based on available attributes and/or patterns, rather than requiring an exact match. Applying a heuristic refers to using a heuristic to assess information and make a determination without requiring an exact or exhaustive analysis. For instance, applying a heuristic may include evaluating available attributes and/or patterns to infer a likely correspondence or match in a way that is efficient and sufficiently accurate for an intended purpose. A match refers to a determined correspondence indicating that two or more items refer to the same and/or related entity based on one or more evaluated criteria. For instance, a match may signify that compared data elements are sufficiently related for mapping and/or correlation purposes. Multiple candidate matches refers to at least two matches (e.g., duplicates and/or equivalences) that plausibly correspond to a particular reference and/or entity, such that additional information may be required to determine which match is a better fit. Multiple candidate matches may include a tie. For instance, one or more of the first map, the second map, or the third map may include one or more one-to-many and/or many-to-one relationships (e.g., ties) between the IAC state data and the provisioned resources, the IAC state data and the set of IAC code definitions, or the set of IAC code definitions and the provisioned resources. At least one processor may apply one or more heuristics to collapse one or more one-to-many and/or many-to-one relationships to one-to-one relationships (e.g., to break the tie).

For instance, at least one processor may apply non-deterministic techniques to identify one or more of: correspondences between the IAC state data and the provisioned resources to establish the first map, correspondences between the IAC state data and the set of IAC code definitions to establish the second map, and/or correspondences between the set of IAC code definitions and the provisioned resources and/or the first map and the second map to establish the third map. In some embodiments, at least one processor may apply a combination of deterministic and non-deterministic assessments to establish any of the first, second, and/or third maps. In some embodiments, at least one processor may apply one or more heuristics to break ties among multiple candidate matches produced by a deterministic attribute-matching process. At least one processor may infer a match between a provisioned resource and an IaC definition based on similarity of naming patterns and/or deployment context, even when no exact identifiers are shared (i.e., pure heuristic matching). As another example, at least one processor may first identify candidate matches using exact attribute equality and then apply one or more heuristics to weight additional attributes, such as creation time proximity and/or shared metadata, to confirm the match (i.e., combined deterministic and heuristic matching). As a further example, when multiple candidate matches satisfy deterministic attribute matching, at least one processor may apply a heuristic that ranks the candidates based on relative configuration similarity to select a single best match (i.e., applying a heuristic for tie-breaking).

In some disclosed embodiments, a first map, a second map, and a third map track configuration changes over time. Tracking refers to observing, recording, and/or maintaining information about something as it changes or progresses over time. Tracking may include maintaining awareness of a state and/or progression of something across time. For instance, tracking may include maintaining a record, monitoring how resource configurations change over time. Thus, a first map, a second map, and a third map that track configuration changes over time may indicate that each map preserves historical and/or sequential relationships between entities (e.g., resources, IaC state data records, and/or IaC code definitions) so that updates, modifications, and/or state transitions may be identified and/or correlated as they occur. For example, the first map may record that an identifier in the IaC state data that corresponded to a specific running instance for a virtual machine when created continues to reflect changes to the running instance over time. As another example, the second map may maintain an association for an entry in the IaC state data derived from a specific IaC code definition, and may update the association as the code definition is modified. As a further example, the third map may link an IaC code definition to provisioned resource instances created from it and track how those instances change as the underlying code definition evolves. In some embodiments, the first, second, and third maps may permit version tracking and/or version correlation over time by maintaining historical correlations, associations, and/or discrepancies. This may enable analysis of the evolution of infrastructure components over time to identify change patterns and/or drift. For instance, version tracking may enable outputting of alerts for uncorrelated and/or weakly correlated cloud assets, resources, and/or IaC code definitions.

By way of a non-limiting example, in FIG. 4, at least one processor (e.g., processor 102 of FIG. 1 included in computing device 302 in FIG. 3) may apply at least one heuristic to determine a match between the IAC state data (e.g., retrieved from IaC state data repositories 304) and resource identifiers for provisioned resources 306 (e.g., retrieved by accessing provisioned resources 306 directly), the IAC state data and the set of IAC code definitions (e.g., retrieved from IaC code definitions 308), and/or the set of IAC code definitions and the resource identifiers for provisioned resources 306 to thereby establish at least one of first map 400, second map 402, or the third map 404. In some embodiments, first map 400, second map 402, and third map 404 track configuration changes (e.g., drift) over time.

Some disclosed embodiments involve identifying at least one discrepancy between the set of IAC code definitions and the provisioned resources based on at least one of the first map, the second map, or the third map, and take a remedial action. Identifying refers to recognizing, ascertaining, and/or discovering, as described elsewhere herein. A discrepancy refers to a difference, delta, and/or inconsistency between two or more entities. A discrepancy may indicate differences between two items (e.g., data) that are expected to be the same and/or aligned. A discrepancy between a set of IaC code definitions and provisioned resources may exist when the actual resources created and/or running in a cloud environment do not fully correspond to what is specified in the infrastructure-as-code definitions. A discrepancy between IaC code definitions and provisioned resources may be indicative of configuration drift. In other words, the intended configuration described in the IaC code definitions differs from the realized configuration in practice. At least one processor may analyze the first, second, and/or third maps to discern differences and/or inconsistencies there between, that may indicate one or more conflicts, incompatibilities, and/or deviations between resource configurations specified by the IaC code definitions and resource configurations actually provisioned in the computing environment. For example, an IaC code definition may specify a storage bucket with encryption enabled, but the provisioned storage bucket may exist without encryption configured. As another example, an IaC code definition may define three compute instances, while in actuality, only two corresponding compute instances may be provisioned and running. As a further example, an IaC code definition for a resource may specify a particular network security rule, but the provisioned resource may reflect a modified and/or missing rule due to a manual change and/or failed update.

A remedial action refers to a measure and/or set of steps taken to correct, mitigate, and/or resolve an identified problem, deficiency, and/or undesired condition. For instance, a remedial action may include notifying an administrator, setting a flag (e.g., for a particular record and/or map entry), proposing a corrective measure, and/or any other action for addressing a discrepancy. By way of example, at least one processor may automatically update IaC state data and/or re-apply an IaC code definition so that a provisioned resource is brought into alignment with the intended configuration (i.e., modify a provisioned resource to accord with an IaC code definition), modify, recreate, and/or remove one or more provisioned resources to resolve a detected mismatch between an actual resource configuration and the configuration defined in the IaC code, and/or update an IaC code definition to reflect intentional changes made directly to a provisioned resource, to eliminate the discrepancy and restore consistency (e.g., modify an IaC code definition to accord with a provisioned resource). As another example, at least one processor may generate a notification, report, and/or flag the discrepancy so that a user and/or system may review and/or address the inconsistency. As a further example, at least one processor may enforce policies and/or constraints, for instance to restrict manual changes to provisioned resources to reduce the likelihood of future discrepancies. In some embodiments, a remedial action may include outputting a report detailing configuration drift and/or providing recommendations for resolving configuration drift. In some embodiments, at least one processor may invoke an AI agent to identify a discrepancy between the IAC code definitions and the provisioned resources, and determine and/or apply a remedial measure.

By way of a non-limiting example, in FIG. 4, at least one processor (e.g., processor 102 in FIG. 1 included in computing device 302 in FIG. 3) may identify at least one discrepancy between the set of IAC code definitions retrieved from IaC code definitions 308 and provisioned resources 306 based on at least one of first map 400, second map 402, or third map 404, and take a remedial action. For instance, an IaC code definition may specify a newer version for a software application, but the corresponding software application included in provisioned resources 306 may be an older version. In response, at least one processor may take a remedial action, such as by alerting an administrator, and/or by triggering an automated process to update the software application to the newer version.

Some disclosed embodiments involve using the third map to produce a regulatory audit. An audit refers to a review, analysis, investigation, and/or evaluation. A regulatory audit refers to an audit for assessing if one or more activities, processes, and/or controls comply with one or more rules, policies, and/or standards. A regulatory audit may facilitate in verifying compliance, identification of gaps and/or risks, and/or provide support for accountability and/or corrective action where needed. For example, a regulatory audit may include examining whether deployed infrastructure, configurations, and/or operational practices conform to regulatory requirements by comparing provisioned resources and their configurations against documented policies, standards, and/or IaC code definitions, and/or identifying discrepancies that may require remediation to maintain compliance. At least one processor may analyze the third map to identify which provisioned resources comply with one or more policies and which provisioned resources fail to comply, and generate a regulatory audit based on the analysis. In some embodiments, at least one processor may cross reference the third map against one or more policies, rules, and/or recommended practices. Such an audit may provide visibility into cloud asset ownership, configuration, and/or lineage. It may aid in compliance assessments by mapping assets and configurations to specific regulatory requirements. In some embodiments, at least one processor may invoke an AI agent to produce a regulatory audit.

Some disclosed embodiments involve generating at least one confidence score for at least one of the first map, the second map, or the third map, and taking a remedial action when the at least one confidence score is below a threshold level. Generating refers to producing, creating, initiating, and/or originating. A confidence score refers to a measure, grade, and/or rating representing a degree of certainty and/or reliability associated with a determination, prediction, and/or match. A confidence score may include a value within a range of values (e.g., low, medium, high, or a number from one to ten), a range of values (e.g., a mean and standard deviation, such as five plus or minus 2), a binary value, and/or any other type of score. A confidence score may indicate how likely a result is to be correct and/or accurate. A confidence score for a map refers to a value and/or range of values) indicating the reliability of relationships captured by the map, i.e., how strongly available evidence supports correspondences indicated by the map. A confidence score may be indicative of an extent of configuration drift. For example, at least one processor may assign a relatively high confidence score (e.g., 0.95) to the first map when resource identifiers and/or key attributes included in an IaC state data entry align closely with a discovered provisioned resource, indicating high likelihood that the IaC state data entry corresponds to that resource. As another example, at least one processor may assign reasonably high confidence score (e.g., 0.80) to the second map when an IaC state data record matches an IaC code definition based on module/address and/or provenance metadata but some signals are incomplete (e.g., partial module chain), indicating a probable but not fully certain linkage. As a further example, at least one processor may assign a mediocre confidence score (e.g., 0.60) to the third map when an IaC code definition can be connected to a provisioned resource only indirectly (e.g., by combining the first and second maps) absent external and/or independent corroborating data, resulting in a lower-confidence score that may be flagged for manual review. In some embodiments, at least one processor may generate a confidence score for each association in each of the first, second, and third maps (i.e., each correspondence). In some embodiments, at least one processor may aggregate confidence scores for individual associations within a given map, and output a confidence score indicative of the overall reliability of that map. In some embodiments, at least one processor may aggregate confidence scores for the first, second, and third maps to produce an overall confidence score for all three maps.

A threshold level refers to a baseline, boundary, tolerance, and/or limit. A threshold level may include a ceiling (i.e., an upper limit), a floor (i.e., a lower limit), a maximum, and/or a minimum. Taking a remedial action when a confidence score is below a threshold level refers to invoking a mitigating measure (as described elsewhere herein) if the confidence score fails to reach a lower limit of trustworthiness and/or reliability. For example, at least one processor may flag the first, second, and/or third maps, and/or individual records included therein for a remedial action if an associated confidence score fails to reach a threshold level, e.g., configuration drift exceeds a threshold level. The flagging may invoke a manual review, an automated measure (e.g., using an AI agent), and/or any other type remedial measure.

By way of a non-limiting example, in FIG. 4, at least one processor (e.g., processor 102 in FIG. 1 included in computing device 302 in FIG. 3) may use third map 404 to produce a regulatory audit. For instance, the audit may highlight any detected discrepancies and/or inconsistencies between provisioned resources 306, IaC state data 304, and/or IaC code definitions 308. In some embodiments, at least one processor may generate one or more confidence scores for first map 400, second map 402, and/or third map 404. At least one processor may take a remedial action when any of the confidence scores are below a threshold level.

Some disclosed embodiments involve visually presenting at least one of the first map, the second map, or the third map via an interactive user interface. Visually presenting refers to displaying information in a graphical and/or visual form. A visual presentation may enable a user to more readily perceive relationships, patterns, and/or states, rather than if conveyed through raw text and/or data structures. Visually presenting may include rendering data as charts, graphs, diagrams, tables, icons, and/or other visual elements on a display to improve comprehension and interpretation. An interactive user interface (UI) refers to a computer generated visual and control layer that permits a user to actively engage with displayed information. An interactive UI may provide visual elements for receiving inputs from a user, and deliver responsive feedback to the inputs as visual and/or other sensory signals. For example, at least one processor may present one or more interactive graphs representing correlations between differing provisioned resources, corresponding IaC state records, and/or IaC code definitions. Such an interactive graph may include interactive elements to permit drilling down and/or viewing additional details (e.g., higher resolution information) for one or more resources, IaC code definitions, and/or IaC state records.

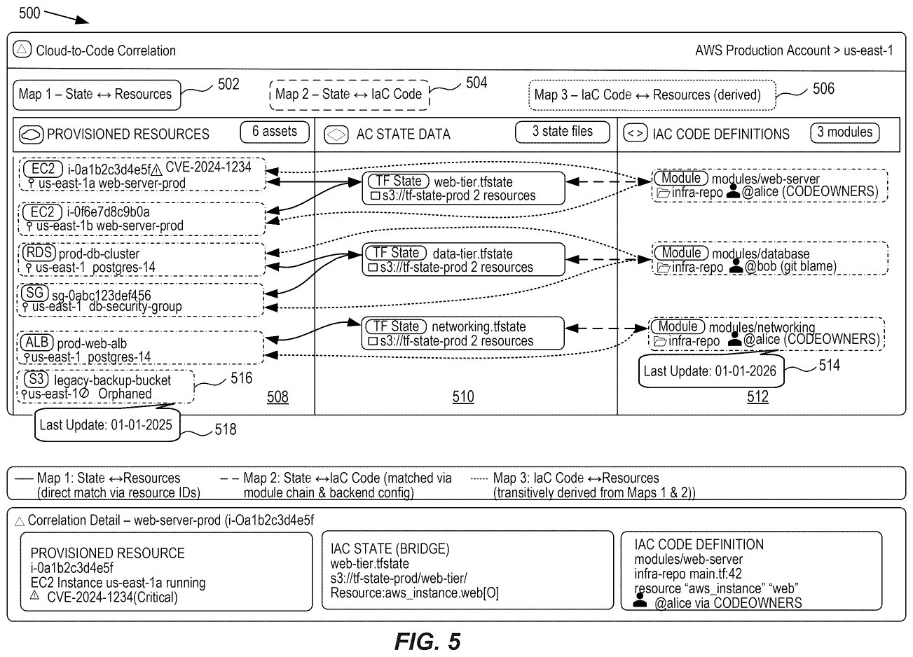

By way of a non-limiting example, reference is made to FIG. 5 which is a depiction of an exemplary interactive user interface 500 presenting the first, second, and third maps, consistent with some disclosed embodiments. Interactive user interface 500 may visually present a first map 502 (e.g., corresponding to first map 400 in FIG. 4), a second map 504 (e.g., corresponding to second map 402), and a third map 506 (e.g., corresponding to third map 404). First map 502 may indicate associations between a list of a plurality of provisioned resources 508 and a list of a plurality of IaC state data records 510 using solid-line arrows. Second map 504 may indicate associations between the list of the plurality of IaC state data records 510 and a list of a plurality of IaC code definitions 512 using dashed-line arrows. Third map 506 may indicate associations between the list of the plurality of provisioned resources 508 and the list of the plurality of IaC code definitions 512 using dotted-line arrows. Interactive user interface 500 may include one or more interactive elements permitting a user to query for and/or view additional details (e.g., metadata) for any of resources, IaC state data records, and/or IaC code definitions represented by the lists of plurality of provisioned resources 508, plurality of IaC state data records 510, and/or plurality of IaC code definitions 512, respectively. For instance, clicking on a particular one of IaC code definitions 512 may cause presentation of a pop-up window 514 permitting a user to query at least one processor (e.g., processor 102 in FIG. 1) for information pertaining to the particular IaC code definition 512, such as a date of the most recent update. Similarly, any of lists of plurality of provisioned resources 508, plurality of IaC state data records 510, and/or plurality of IaC code definitions 512 presented via interactive user interface 500 may include one or more interactive elements permitting a user and/or administrator to query and/or receive additional information associated with any resources, IaC state records, and/or IaC code definitions included in lists of plurality of provisioned resources 508, plurality of IaC state data records 510, and/or plurality of IaC code definitions 512.

Some disclosed embodiments involve exposing an Application Programming Interface (API) for accessing at least one of the first map, the second map, or the third map. An Applications Programming Interface (API) refers to a set of rules and/or protocols permitting different software applications and/or systems to communicate and/or interact with each other in a standardized and/or controlled manner. An API for accessing a map refers to an API permitting retrieval, query, and/or interaction with data represented in the map. Such an API may be associated with defined requests and/or responses to interacting with a map, e.g., without requiring direct access to underlying data structures. For example, an API may expose one or more structured endpoints through which an external system, service, and/or application may request information about associations captured in a map (e.g., relationships, attributes, or confidence scores), and receive corresponding data in a standardized format. An API for accessing the first, second, and/or third map may enable automated integration, analysis, and/or downstream processing while preserving abstraction and access control. Such an API may expose correlations and/or associations captured in the first, second, and/or third maps to an external system (e.g., including an AI agent), permitting programmatic queries for resource-to-IaC relationships.

By way of a non-limiting example, in FIG. 4, at least one processor (e.g., processor 102 in FIG. 1 included in computing device 302 in FIG. 3) may expose an Application Programming Interface (API) for accessing first map 400, second map 402, and/or third map 404. In some embodiments, at least one processor may analyze first map 400, second map 402, and/or third map 404 to identify a pattern associated with an infrastructure change (e.g., to any of provisioned resources 306), and to predict future infrastructure needs based on the at least one pattern. For instance, at least one processor may determine that data repository 314A and associated computing device 316A should be scaled to accommodate projected demand, based on an associated demand pattern.

Some disclosed embodiments involve analyzing at least one of the first map, the second map, or the third map to identify at least one pattern associated with an infrastructure change, and to predict future infrastructure needs based on the at least one pattern. To analyze refers to examining, investigating, organizing, and/or interpreting, as described elsewhere herein. Identifying refers to recognizing, ascertaining, and/or discovering, as described elsewhere herein. A pattern refers to a recognizable and/or recurring arrangement, relationship, and/or sequence that may be observed across multiple instances and/or over time. A pattern may include a trend, a tendency, a bias, and/or a course of progression. An infrastructure change refers to a modification of an infrastructure component within a computing environment. An infrastructure change may include an addition, removal, update, and/or other modification to one or more infrastructure components. An infrastructure change may affect how infrastructure resources are provisioned, configured, and/or operated, and may alter a state and/or behavior of an infrastructure component, and/or alter a relationship between infrastructure components. For example, an infrastructure change may occur if a new compute instance is provisioned, resized, and/or terminated within a cloud environment, resulting in an alteration to available resources and their configurations, and affecting system capacity and/or behavior. As another example, an infrastructure change may occur if a network configuration, security rule, and/or access policy is updated (e.g., by modifying firewall rules or load-balancer settings). Such a change may impact connectivity, security posture, and/or traffic flow. As a further example, an infrastructure change may occur if an IaC code definition is updated and subsequently applied to an environment, resulting in the creation, modification, and/or replacement of one or more provisioned resources, transitions the environment to a new state.

To predict refers to estimate, forecast, and/or anticipate an event, outcome, and/or condition. A prediction may be based on observed information, prior knowledge, experience, determined correlations, and/or logical inference. Future infrastructure needs refers to anticipated resources, capabilities, and/or capacity that a computing environment may require at a later time in order to continue operating effectively and support expected changes and/or demands. This may include identifying what additional and/or modified infrastructure components (e.g., compute capacity, storage, networking, security controls, and/or management capabilities) may be required as workloads grow, configurations evolve, usage patterns change, and/or new applications and services are planned. To predict future infrastructure needs based on a pattern may include estimating and/or forecasting future infrastructure needs based on a trend and/or tendency gleaned from the first, second, and/or third map. At least one processor may analyze correlated data captured in the first, second, and/or third maps to generate predictive insights for future infrastructure needs based on observed patterns, e.g., by enlisting an AI agent. For example, analysis of the first map may reveal a recurring pattern in which increases in IaC state entries consistently correspond to repeated provisioning of additional compute resources over time. At least one processor may identify this as a pattern associated with scaling-related infrastructure changes and predict a future need for increased compute capacity or resource quotas. As another example, analysis of the second map may indicate a pattern in which modifications to specific IaC code definitions are frequently followed by corresponding updates in IaC state data. At least one processor may identify this as a pattern of iterative configuration evolution and predict a future need for enhanced configuration management, versioning support, and/or additional IaC modules. As a third example, analysis of the third map may indicate a pattern in which a particular IaC code definition repeatedly results in creation of multiple provisioned resources across environments. At least one processor may associate this pattern with expansion-driven infrastructure changes and predict a future need for additional networking, storage, and/or security infrastructure to support the expanded resource footprint.

By way of a non-limiting example, in FIG. 4, at least one processor (e.g., processor 102 in FIG. 1 included in computing device 302 in FIG. 3) may expose an Application Programming Interface (API) for accessing first map 400, second map 402, and/or third map 404. In some embodiments, at least one processor may analyze first map 400, second map 402, and/or third map 404 to identify a pattern associated with an infrastructure change (e.g., to any of provisioned resources 306), and to predict future infrastructure needs based on the at least one pattern. For instance, at least one processor may determine that resource 314A should be scaled to accommodate projected demand, based on an associated demand pattern.

Some disclosed embodiments involve using at least one of the first map, the second map, or the third map to identify an orphaned resource omitted from the third map, and to take a remedial action based on the identified orphaned resource. An orphaned resource refers to an infrastructure component that is provisioned in a computing environment but lacks an associated reference, and/or use by an application, workload, and/or entry in state data and/or IaC code definitions. For example, an orphaned resource may arise when a resource is created but its corresponding code definition, state record, and/or consuming dependency is removed and/or no longer present. This may leave the resource detached and/or unmanaged while still consuming capacity, incurring cost, and/or introducing operational or security risk. For example, at least one processor may compare provisioned resources discovered in an environment against associations captured in the third map and determine that a particular provisioned resource does not appear in the third map. In such a case, the at least one processor may identify the provisioned resource as an orphaned resource omitted from the third map. As another example, at least one processor may use the first map and/or the second map to confirm that a provisioned resource is not associated with any corresponding IaC state data or IaC code definition. In such a case, the at least one processor may further validate that the provisioned resource is unmanaged and therefore orphaned. As a further example, at least one processor may determine, based on absence of a provisioned resource from the third map and a lack of corroborating associations in at least one of the first or second maps, that no active IaC definition governs the resource. In such a case, the at least one processor may classify the resource as an orphaned resource.

To take a remedial action refers to applying and/or invoking a measure and/or set of steps to correct, mitigate, and/or resolve an identified problem, deficiency, and/or undesired condition, as described elsewhere herein. For example, at least one processor may determine that an orphaned resource is not associated with any IaC code definition or active workload. In such a case, the at least one processor may initiate deletion and/or de-provisioning of the orphaned resource to eliminate unused infrastructure and reduce cost or risk. As another example, at least one processor may determine that an orphaned resource corresponds to an intended but missing IaC definition. In such a case, the at least one processor may generate and/or update an IaC code definition and/or state entry to re-associate the orphaned resource with managed infrastructure. As a further example, at least one processor may identify an orphaned resource and flag the orphaned resource to generate a notification and/or report for manual review and/or approval prior to taking further action.

Some disclosed embodiments involve identifying a vulnerability associated with at least one of the provisioned resources. A vulnerability refers to a susceptibility, weakness, exposure, and/or or flaw. For example, a vulnerability may include a systemic flaw in a component, configuration, and/or process that may be exploited and/or triggered to compromise security, reliability, or proper operation. A vulnerability may exist in software, hardware, configuration settings, operational controls, and/or any other aspect of a computing system. A vulnerability may allow a threat to adversely affect confidentiality, integrity, availability, and/or compliance if the weakness is not addressed. Some non-limiting examples of vulnerabilities may include unpatched and/or outdated software, misconfiguration of access controls, weak authentication practices, and/or orphaned resources. As another example, a vulnerability may occur when IaC code contains a misconfiguration, such as an overly permissive access policy or publicly exposed resource. Because IaC definitions are reusable and automated, a single misconfigured template may repeatedly deploy infrastructure with insecure network. As an additional example, a vulnerability may occur due to improper handling of sensitive IaC state data (e.g., credentials, access tokens, and/or resource identifiers) in plain text. As a further example, a vulnerability may occur when state data becomes inaccurate or unmanaged, such as through configuration drift or unauthorized modification of a state file. In such cases, IaC tooling may no longer accurately reflect the actual infrastructure, potentially masking insecure resources, and preventing detection of misconfigurations, or enabling unintended changes that introduce security risk. In some embodiments, at least one processor may enlist an AI agent to analyze the first, second, and/or third map to identify one or more vulnerabilities.

Some disclosed embodiments involve using at least one of the first map, the second map, or the third map to take a remedial action based on the identified vulnerability. For example, based on the first map, at least one processor may identify that a provisioned resource associated with IaC state data exhibits a vulnerable configuration state. The processor at least one processor may initiate a remedial action by modifying the provisioned resource to conform to a secure configuration reflected in updated state data. As another example, at least one processor may determine, using the second map, that an IaC code definition corresponding to IaC state data contains a vulnerability. In such a case, the at least one processor may take a remedial action by updating the IaC code definition and causing the updated definition to be applied to remediate the vulnerability at the code level. As a further example, at least one processor may identify, based on the third map, that a provisioned resource governed by an IaC code definition is affected by a vulnerability. The at least one processor may take a remedial action by regenerating and/or redeploying the provisioned resource using a corrected IaC code definition to eliminate the vulnerability. In some embodiments, at least one processor may enlist an AI agent to determine and/or apply a remedial action to address a vulnerability. The analysis of the first, second, and/or third maps may facilitate identification of vulnerable cloud assets and streamline an investigation process.

In some disclosed embodiments, the remedial action includes using the third map to locate from the set of IAC code definitions an IAC code definition corresponding to the at least one of the provisioned resources and outputting a remediation for the IAC code definition. To locate refers to identify, discover, detect, and/or determine. To locate an IAC code definition corresponding a provisioned resources associated with a vulnerability refers to analyzing the IaC code definition to identify one or more attributes that enable establishing an identify of a provisioned resource that may be affected by the vulnerability. At least one processor may use the third map to trace an affected resource back to the IaC code definition that created and/or governs the affected resource. Outputting refers to providing and/or producing. A remediation refers to an act that rectifies, fixes, repairs, and/or otherwise addresses a vulnerability. Outputting a remediation may include suggesting and/or recommending a remediation (e.g., via a GUI), and/or applying a remediation to an IAC code definition associated with the affected resource. For instance, upon discovering a vulnerability affecting a provisioned resource, at least one processor may analyze the third map to trace the IaC code definition responsible for provisioning and/or governing the resource, and suggest an alteration to the traced IaC code definition to an administrator.

By way of a non-limiting example, in FIGS. 3 and 4, at least one processor (e.g., processor 102 in FIG. 1 included in computing device 302) may use first map 400, second map 402, and/or third map 404 to identify an orphaned resource (e.g., data repository 314C) omitted from third map 404. At least one processor may take a remedial action based on the identified orphaned resource. In some embodiments, at least one processor may identify a vulnerability associated with one of provisioned resources 306. For instance, orphaned resource 314C may indicate a vulnerability. At least one processor may use first map 400, second map 402, and/or third map 404 to take a remedial action based on the identified vulnerability. For instance, at least one processor may trigger an automated process to update IaC state data 304 with a current state for orphaned resource 314C, and/or notify an administrator. In some embodiments, the remedial action may include using third map 404 to locate from IAC code definitions 308 an IAC code definition corresponding to provisioned resource 314C and outputting a remediation for the IAC code definition. For instance, the remediation may update the IaC code definition for provisioned resource 314C in a manner to resolve the orphaned status.

By way of another non-limiting example, in FIG. 5, at least one processor may use first map 502, second map 504, and/or third map 506 to identify an orphaned resource 516 omitted from third map 404, e.g., lacking a dotted-line arrow connecting orphaned resource 516 with any of IaC code definitions 512. At least one processor may take a remedial action based on identified orphaned resource 516. For instance, in response to a click event associated with orphaned resource 516, at least one processor may present, via interactive user interface 500, a pop-up window 518 indicating that the last update for orphaned resource 516 in occurred on Jan. 1, 2025, rendering that resource as obsolete. An administrator and/or automated agent may use the additional information to take a suitable remedial action, such as by triggering an update or shut-down for orphaned resource 516.

Some disclosed embodiments involve detecting a security incident. A security incident refers to an event that compromises, or has potential to compromise the protection, integrity, and/or availability of systems, data, and/or resources. For example, a security incident may include unauthorized access, misuse, disclosure, modification, disruption, and/or destruction of systems or data, whether caused by malicious activity, accidental actions, or control failures. A security may constitute a violation or imminent threat of violation of security policies, procedures, and/or acceptable-use requirements. Some disclosed embodiments involve using at least one of the first map, the second map, or the third map to identify a party associated with a security incident. A party associated with a security incident refers to a user (e.g., a human), an agent (e.g., an AI agent), a process, an operator, and/or an account linked to an event capable of compromising a cloud system. For example, at least one processor may analyze the first map to determine an identity of a party that last modified, applied, and/or managed IaC state data associated with a provisioned resource affected by a security incident, thereby linking the security incident to the party. As another example, at least one processor may analyze the second map to determine an identity of a party who authored, approved, and/or changed an IaC code definition mapped to a state data record involved in a security incident, e.g., via version-control or by analyzing change-tracking metadata. As an additional example, at least one processor may use the third map to correlate a provisioned resource affected by a security incident with an IaC code definition that created and/or governs the affected resource. The at least one processor may determine a party associated with specifying and/or deploying the IaC code definition.

Some disclosed embodiments involve identifying at least one of the provisioned resources affected by a security incident. A provisioned resource affected by a security incident refers to a deployed infrastructure component that has been accessed, altered, disrupted, and/or otherwise involved in an event that compromises, or has the potential to compromise, the integrity, availability, and/or intended operation of the component or the data it handles. For example, at least one processor may analyze the first map to detect that IaC state data associated with a resource reflects an unexpected or unauthorized change. For example, the processor may determine that state attributes for the resource differ from a previously recorded baseline in a manner consistent with a security incident (such as altered access settings). As another example, at least one processor may analyze the second map to determine that IaC state data associated with an affected resource maps to an IaC code definition that has been flagged as involved in the incident, e.g., by discovering that the code definition corresponding to the state data was modified, misused, or otherwise implicated in the incident. As a further example, at least one processor may analyze the third map to trace an IaC code definition implicated in a security incident to a provisioned resources created and/or governed by that definition. The processor may use the third map to indicate each provisioned resource corresponding to the IaC code definition as affected by the security incident.

By way of a non-limiting example, in FIG. 4, at least one processor (e.g., processor 102 in FIG. 1 included in computing device 302 in FIG. 3) may detect a security incident. At least one processor may use first map 400, second map 402, and/or third map 404 to identify a party associated with a security incident and one of provisioned resources 306 affected by the security incident. For instance, at least one processor may identify data repository 314B as affected by the security incident, e.g., a data breach, indicated by the IaC state data. In some embodiments, at least one processor may use first map 400, second map 402, and/or third map 404 to trace ownership of any of computing devices 316A-316C and/or associated data repositories 314A-314C.

In some disclosed embodiments, the provisioned resources include Kubernetes resources, the IAC state data includes Helm release state data, and the set of IAC code definitions includes Helm charts, and wherein the at least one processor is further configured to establish the first map by matching Kubernetes resources to Helm release state data based on at least one of a resource type, label, or namespace, and establish the second map by matching Helm release state data to a Helm chart based on at least one of chart metadata, a template file structure, and dependent chart information. A Kubernetes resource refers to an Application Programming Interface (API) object that represents a specific component or capability of a Kubernetes cluster. It may include a workload, configuration, networking element, and/or policy. It may be declaratively defined and managed to maintain a desired state. Helms release state data refers to persisted metadata for a release that records one or more of a release's identity, revision history, configuration values, rendered manifests, and/or current lifecycle status (e.g., deployed, failed, or superseded). It may be used to track and manage the state of a chart instance in a Kubernetes cluster. A Helms chart refers to a versioned package including a structured collection of files that describe a related set of resources. A processor may use a Helms chart to define, install, and/or manage an application or service. A resource type refers to a classification and/or category for a resource, as described elsewhere herein. A label refers to a tag, annotation, and/or metadata as described elsewhere herein. A namespace refers to a logical partition for organizing and/or isolating resources, where resource names must be unique within the namespace while the same names may be reused across different namespaces. Chart metadata refers to auxiliary information (e.g., metadata as described elsewhere herein) associated with a Helms chart. A template file structure refers to an organized arrangement of template files and/or directories. It may define how reusable, parameterized files may be arranged, named, and/or associated with other files, such that variables and placeholders may be consistently rendered into a concrete configuration and/or resource definition during generation or deployment. Dependent chart information refers to metadata declared for a dependencies for a Helm chart. It may be specified for a parent chart and may identify additional charts required for the parent chart to function. It may include a name, version, and/or source depository for each chart on which the parent chart depends, enabling at least one processor to install multiple dependent charts together.

Some disclosed embodiments involve using at least one of the first map, the second map, or the third map to trace ownership of at least one of the provisioned resources. Ownership of a provisioned resource refers to an association between the provisioned resource with a party that has authority over, and/or accountability for, the creation, configuration, operation, and/or lifecycle management of the resource. Ownership may be attributed to an individual, a team, a service account, a process, an AI agent, and/or an organization identified as having control rights and/or stewardship responsibilities for the provisioned resource. For instance ownership may be associated with approving changes, responding to incidents, and/or ensuring compliance with applicable policies. At least one processor may derive ownership from metadata, access controls, IaC code definitions, state data, deployment pipelines, and/or any other information indicating who or what provisioned, manages, and/or governs the resource. For example, using the first map, at least one processor may identify IaC state data corresponding to a provisioned resource and determine ownership by examining associated metadata indicating an identity that last applied, modified, or managed the state data, and tracing ownership of the provisioned resource to that identity. As another example, using the second map, at least one processor may trace ownership by mapping IaC state data associated with a provisioned resource to an IaC code definition, and then associate that code definition with a responsible party. For example, the processor may identify an owner of a repository, module, and/or configuration file containing the IaC code definition and determine that the provisioned resource is owned by the same party. As a further example, using the third map, at least one processor may identify an IaC code definition corresponding to a provisioned resource and then associate the identified code definition with a deployment pipeline, service account, process, and/or team responsible for provisioning resources using that definition. In some embodiments, at least one processor may integrate the first, second, and/or third map with a Continuous Integration (CI) source, such as Git® to identify candidates as owners for one or more resources and/or clous assets.

In some disclosed embodiments, tracing ownership includes analyzing version control metadata associated with the set of IAC code definitions to identify a party responsible for the at least one of the provisioned resources, wherein the version control metadata includes at least one of commit authorship, code ownership files, or deployment pipeline records. Version control metadata refers to recorded information describing a history, context, and/or authorship of changes, as described elsewhere herein. Commit authorship refers to attribution metadata associated with a snapshot of changes to one or more tracked files (i.e., a version control commit), capturing a state of the files at a specific point in time. Commit authorship may be used to identify an individual and/or an automated agent associated with changes reflected in a version control commit, and may be independent of a party recording and/or applying a commit. A code ownership file refers to a configuration file associating specific files, directories, and/or patterns in a codebase with one or more designated individuals and/or teams. Consequently, changes affecting the specific files, directories, and/or patterns may be attributed to, reviewed by, and/or require approval from the identified owner. A deployment pipeline refers to an automated workflow that deploys software changes from source code toward a running environment, typically by progressing the changes through a sequence of defined stages, e.g., to build, verify, and release the changes in a controlled and repeatable manner. A deployment pipeline record refers to data capturing execution details of an implementation of a deployment pipeline. It may include which stages were performed, which artifacts and/or configurations were processed, outcomes of automated checks, and/or timestamps or identifiers associated with the release. Such a record may permit tracking and/or auditing a progression of a change from build through deployment. Analyzing refers to examining, investigating, organizing, and/or interpreting, as described elsewhere herein. In some embodiments, analyzing may including integrating, merging, and/or combining one data set with another data set. A party responsible for a provisioned resources refers to an entity in charge of, and/or obligated to manage, and/or control the provisioned resource. For example, once a resource is created, a responsible party may monitor its operational state, ensure that its configuration remains consistent with the governing definition or policy, and/or take remedial action if the resource deviates from expected behavior. Such a party may be expected to manage access, apply updates and/or changes when instructed, and decommission and/or transfer responsibility for the resource when it is no longer needed or no longer within that party's scope of control. At least one processor may analyze version control data to identify one or more parties responsible for a particular version of a provisioned resource, e.g., to permit enforcement of access controls, assignment of responsibility for review or remediation, and/or generation of an auditable record linking deployed resources to accountable individuals and/or teams.

By way of a non-limiting example, in FIG. 4, at least one processor (e.g., processor 102 in FIG. 1) may use at least one of first map 400, second map 402, or third map 404 to trace ownership of at least one of provisioned resources 306. In some embodiments, at least one processor may analyze version control metadata associated with IAC code definitions 308 to identify a party responsible for provisioned resources 306. The version control metadata may include at least one of commit authorship, code ownership files, or deployment pipeline records. In some embodiments, provisioned resources 306 may include Kubernetes resources, IAC state data 304 may include Helm release state data, and IAC code definitions 308 may include Helm charts. In some embodiments, at least one processor may establish first map 400 by matching Kubernetes resources to Helm release state data based on at least one of a resource type, label, or namespace, and establish second map 402 by matching Helm release state data to a Helm chart based on at least one of chart metadata, a template file structure, and dependent chart information.

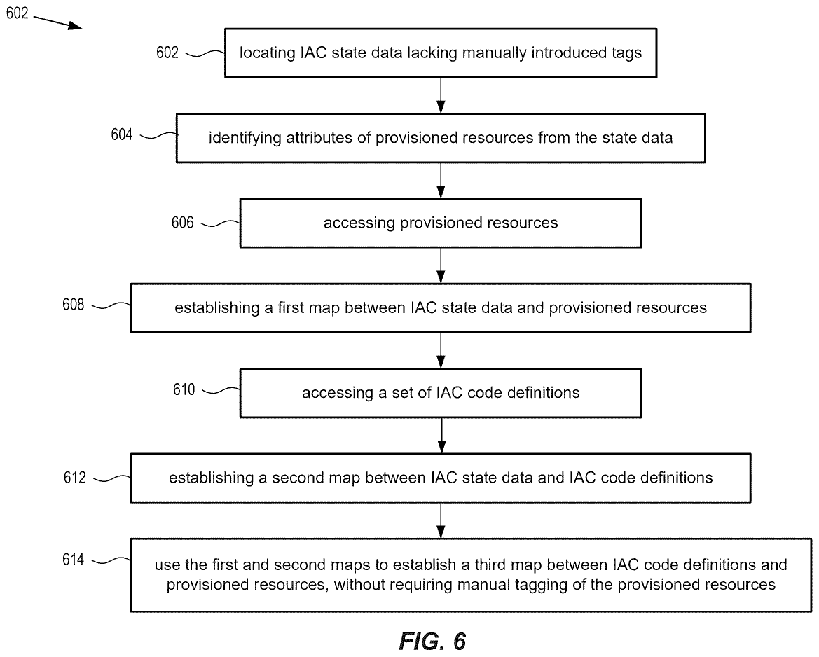

FIG. 6 is a flowchart of example process 600 for identifying infrastructure-as-code (IAC) associated with cloud assets, consistent with embodiments of the present disclosure. In some embodiments, process 600 may be performed by at least one processor (e.g., processor 102 in FIG. 1) to perform operations or functions described herein. In some embodiments, some aspects of process 600 may be implemented as software (e.g., program codes or instructions) that are stored in a memory (e.g., memory 104) or a non-transitory computer readable medium. In some embodiments, some aspects of process 600 may be implemented as hardware (e.g., a specific-purpose circuit). In some embodiments, process 600 may be implemented as a combination of software and hardware. It should be understood that the steps of process 600 may be performed in any suitable order and may be carried out by one or more processors or other relevant entities within a cloud platform.

Process 600 may include a step 602 of locating IAC state data. By way of a non-limiting example, in FIG. 3, at least one processor (e.g., processor 102 of FIG. 1 included in computing device 302) may locate IaC state data, e.g., by locating IaC state data repositories 310A-310C and/or plurality of associated computing devices 312A-312C included in IaC state data 304.

Process 600 may include a step 604 of analyzing IAC state data to identify attributes of associated provisioned resources, wherein the IAC state data lacks manually introduced tags. By way of a non-limiting example, in FIG. 3, at least one processor (e.g., processor 102 of FIG. 1 included in computing device 302) may analyze the IAC state data to identify attributes of associated provisioned resources 306. The IaC state data retrieved from IaC state data 304 may lack manually introduced tags.

Process 600 may include a step 606 of accessing provisioned resources. By way of a non-limiting example, in FIG. 3, at least one processor (e.g., processor 102 of FIG. 1 included in computing device 302) access provisioned resources 306, e.g., by communicating with computing devices 316A-316C and/or associated data repositories 314A-314C via network 204 using the identified attributes.

Process 600 may include a step 608 of establishing a first map between IAC state data and provisioned resources based on identified attributes. By way of a non-limiting example, in FIG. 4, at least one processor (e.g., processor 102 in FIG. 1 included in computing device 302 in FIG. 3) may establish first map 400 between IaC state data 304 and provisioned resources 306.

Process 600 may include a step 610 of accessing a set of IAC code definitions. By way of a non-limiting example, in FIG. 3, at least one processor (e.g., processor 102 in FIG. 1 included in computing device 302) may access IaC code definitions 308, e.g., by accessing data repositories 318A-318C via computing devices 320A-320C over network 204.

Process 600 may include a step 612 of establishing a second map between IAC state data and a set of IAC code definitions. By way of a non-limiting example, in FIG. 4, at least one processor (e.g., processor 102 in FIG. 1 included in computing device 302 in FIG. 3) may establish a second map 402 between IaC state data 304 and the set of IaC code definitions 308.

Process 600 may include a step 614 of based on a first map and a second map, establishing a third map between a set of IAC code definitions and provisioned resources, thereby mapping the set of IAC code definitions to the provisioned resources without requiring manual tagging of the provisioned resources. By way of a non-limiting example, in FIG. 4, at least one processor (e.g., processor 102 in FIG. 1 included in computing device 302 in FIG. 3) may establish a third map 404 between IAC code definitions 308 and provisioned resources 306 based on first map 400 and second map 402. At least one processor may thereby map IAC code definitions 308 to provisioned resources 306 without requiring manual tagging of the provisioned resources.

Disclosed embodiments may improve the operation of cloud computing systems by linking provisioned resources with their originating infrastructure-as-code definitions in a continual and/or automated manner for improved performance, accuracy, and efficiency. The linking of provisioned resources to their IaC definitions may be achievable even in the absence of human-applied metadata.

Systems that rely on manual tagging to detect configuration drift may suffer from several structural drawbacks that limit accuracy, scalability, and reliability of drift detection. Because tags must be applied and maintained by humans, they are inherently error-prone, inconsistent, and incomplete. This may lead to blind spots where drift goes undetected because a resource was never tagged or was tagged incorrectly. Manual tagging may introduce non-deterministic delays, e.g., due to latencies inherent to human workflows and/or staffing limitations. Consequently, manually introduced tags may lag behind real configuration changes, leading to obsolete and/or inconsistent tags, causing drift detection to operate on stale and/or misleading metadata. As environments scale, systems reliant on manual tagging may become increasingly brittle, since tag governance may depend on sustained human discipline across teams, tools, and/or workflows. As a result, drift-detection may break down, particularly in dynamic, fast-changing cloud environments where reliable drift detection is most critical. This may increase the risk of security breaches, performance degradation, and operational instability (e.g., due to unauthorized changes going unnoticed), and undermine the reliability of security, compliance and remediation controls that depend on accurate system state.

By providing an automated system to detect configuration drift, disclosed embodiments may overcome at least some of these drawbacks, leading to improved performance, security, compliance, and/or reliability. Disclosed embodiments may permit continuous and/or automated detection of configuration drift, which may lead to earlier, wider, and/or deeper detection of discrepancies than systems reliant on manual tagging. Earlier detection (e.g., due to the capability of automated systems to replicate and operate continually) may permit earlier remediation of discrepancies than systems reliant on manual tagging. Wider and/or deeper detection may permit detection of discrepancies missed or overlooked by systems reliant on manual tagging. This may permit detection of discrepancies before a security breach and/or performance degradation occurs, and/or while a security breach and/or performance degradation due to configuration drift is within a limited scope and/or scale. As a result, the cost for remediation may be reduced, while the effectiveness of remediation may be improved over what is achievable using systems reliant on manual tagging.

The disclosed embodiments thus may provide a concrete, computer-implemented solution to a problem rooted in cloud computing technology, namely, the inability of systems dependent on human-applied metadata to reliably and continuously detect configuration drift in dynamic, automated environments. The disclosed techniques may thus improve the functioning of cloud management systems by enabling continuous and/or automated drift detection based on actual system state.

Examples of inventive concepts are contained in the following clauses which are an integral part of this disclosure:
Clause 1: A system for identifying infrastructure-as-code (IAC) associated with cloud assets, the system comprising: at least one processor configured to: locate IAC state data; analyze the IAC state data to identify attributes of associated provisioned resources, wherein the IAC state data lacks manually introduced tags; access the provisioned resources; establish a first map between the IAC state data and the provisioned resources based on the identified attributes; access a set of IAC code definitions; establish a second map between the IAC state data and the set of IAC code definitions; and based on the first map and the second map, establish a third map between the set of IAC code definitions and the provisioned resources, thereby mapping the set of IAC code definitions to the provisioned resources without requiring manual tagging of the provisioned resources.
Clause 2: The system of clause 1, wherein the identified attributes include at least one of a resource name, a resource type, a resource identifier, or a module chain.
Clause 3: The system of any of clauses 1-2, wherein the provisioned resources include at least one of cloud resources, managed resources, managed computing infrastructure resources, or on-premise resources.
Clause 4: The system of any of clauses 1-3, wherein the IAC state data includes at least one of Terraform state data, Helm state data, Pulumi state data, or CloudFormation stack state data.
Clause 5: The system of any of clauses 1-4, wherein the set of IAC code definitions includes at least one of a Pulumi program, a Terraform module, a CloudFormation template, an ARM template, a Bicep template, or a Helm chart.
Clause 6: The system of any of clauses 1-5, wherein the set of IAC code definitions includes a plurality of reusable blueprints for provisioning a plurality of resources, and wherein each provisioned resource corresponds to a single reusable blueprint.
Clause 7: The system of any of clauses 1-6, wherein the at least one processor is further configured to apply at least one heuristic to disambiguate among multiple candidate matches between at least the IAC state data and the provisioned resources, the IAC state data and the set of IAC code definitions, or the set of IAC code definitions and the provisioned resources to thereby establish at least one of the first map, the second map, or the third map.
Clause 8: The system of any of clauses 1-7, wherein at least some of the provisioned resources are associated with differing cloud service providers.
Clause 9: The system of any of clauses 1-8, wherein the first map, the second map, and the third map track configuration changes over time.
Clause 10: The system of any of clauses 1-9, wherein the at least one processor is further configured to identify at least one discrepancy between the set of IAC code definitions and the provisioned resources based on at least one of the first map, the second map, or the third map, and take a remedial action.
Clause 11: The system of any of clauses 1-10, wherein the at least one processor is further configured to use the third map to produce a regulatory audit.
Clause 12: The system of any of clauses 1-11, wherein the at least one processor is further configured to generate at least one confidence score for at least one of the first map, the second map, or the third map, and take a remedial action when the at least one confidence score is below a threshold level.
Clause 13: The system of any of clauses 1-12, wherein the at least one processor is further configured to visually present at least one of the first map, the second map, or the third map via an interactive user interface.
Clause 14: The system of any of clauses 1-13, wherein the at least one processor is further configured to expose an Application Programming Interface (API) for accessing at least one of the first map, the second map, or the third map.
Clause 15: The system of any of clauses 1-14, wherein the at least one processor is further configured to analyze at least one of the first map, the second map, or the third map to identify at least one pattern associated with an infrastructure change, and to predict future infrastructure needs based on the at least one pattern.
Clause 16: The system of any of clauses 1-15, wherein the at least one processor is further configured to use at least one of the first map, the second map, or the third map to identify an orphaned resource omitted from the third map, and to take a remedial action based on the identified orphaned resource.
Clause 17: The system of any of clauses 1-16, wherein the at least one processor is further configured identify a vulnerability associated with at least one of the provisioned resources, and use at least one of the first map, the second map, or the third map to take a remedial action based on the identified vulnerability.
Clause 18: The system of any of clauses 1-17, wherein the remedial action includes using the third map to locate from the set of IAC code definitions an IAC code definition corresponding to the at least one of the provisioned resources and outputting a remediation for the IAC code definition.
Clause 19: The system of any of clauses 1-18, wherein the at least one processor is further configured to detect a security incident and use at least one of the first map, the second map, or the third map to identify a party associated with the security incident, and to identify at least one of the provisioned resources affected by the security incident.
Clause 20: The system of any of clauses 1-19, wherein the provisioned resources include Kubernetes resources, the IAC state data includes Helm release state data, and the set of IAC code definitions includes Helm charts, and wherein the at least one processor is further configured to establish the first map by matching Kubernetes resources to Helm release state data based on resource kind, labels, and namespace, and establish the second map by matching Helm release state data to Helm charts based on chart metadata, template file structure, and dependent chart information.
Clause 21: The system of any of clauses 1-20, wherein the at least one processor is further configured to use at least one of the first map, the second map, or the third map to trace ownership of at least one of the provisioned resources.
Clause 22: The system of any of clauses 1-21, wherein tracing ownership includes analyzing version control metadata associated with the set of IAC code definitions to identify a party responsible for the at least one of the provisioned resources, wherein the version control metadata includes at least one of commit authorship, code ownership files, or deployment pipeline records.
Clause 23: A method for identifying infrastructure-as-code (IAC) associated with cloud assets, the method comprising: locating IAC state data; analyzing the IAC state data to identify attributes of associated provisioned resources, wherein the IAC state data lacks manually introduced tags; accessing the provisioned resources; establishing a first map between the IAC state data and the provisioned resources based on the identified attributes; accessing a set of IAC code definitions; establishing a second map between the IAC state data and the set of IAC code definitions; and based on the first map and the second map, establishing a third map between the set of IAC code definitions and the provisioned resources, thereby mapping the set of IAC code definitions to the provisioned resources without requiring manual tagging of the provisioned resources.
Clause 24: A non-transitory computer readable medium containing instructions that when executed by at least one processor cause the at least one processor to perform operations for identifying infrastructure-as-code (IAC) associated with cloud assets, the operations comprising: locating IAC state data; analyzing the IAC state data to identify attributes of associated provisioned resources, wherein the IAC state data lacks manually introduced tags; accessing the provisioned resources; establishing a first map between the IAC state data and the provisioned resources based on the identified attributes; accessing a set of IAC code definitions; establishing a second map between the IAC state data and the set of IAC code definitions; and based on the first map and the second map, establishing a third map between the set of IAC code definitions and the provisioned resources, thereby mapping the set of IAC code definitions to the provisioned resources without requiring manual tagging of the provisioned resources.

Disclosed embodiments may include any one of the following bullet-pointed features alone or in combination with one or more other bullet-pointed features, whether implemented as a system and/or method, by one or more hardware components disclosed herein, as well as by at least one processor or circuitry, and/or stored as executable instructions on non-transitory computer readable media or computer readable media.
identifying infrastructure-as-code (IAC) associated with cloud assets;
locate IAC state data;
analyze the IAC state data to identify attributes of associated provisioned resources;
IAC state data lacks manually introduced tags;
access the provisioned resources;
establish a first map between IAC state data and provisioned resources based on identified attributes;
access a set of IAC code definitions;
establish a second map between IAC state data and a set of IAC code definitions;
based on a first map and a second map, establish a third map between a set of IAC code definitions and provisioned resources;
mapping a set of IAC code definitions to provisioned resources without requiring manual tagging of provisioned resources;
identified attributes include at least one of a resource name, a resource type, a resource identifier, or a module chain;
provisioned resources include at least one of cloud resources, managed resources, managed computing infrastructure resources, or on-premise resources;
IAC state data includes at least one of Terraform state data, Helm state data, Pulumi state data, or CloudFormation stack state data;
a set of IAC code definitions includes at least one of a Pulumi program, a Terraform module, a CloudFormation template, an ARM template, a Bicep template, or a Helm chart;
a set of IAC code definitions includes a plurality of reusable blueprints for provisioning a plurality of resources;
each provisioned resource corresponds to a single reusable blueprint;
apply at least one heuristic to disambiguate among multiple candidate matches between at least IAC state data and provisioned resources, IAC state data and a set of IAC code definitions, or a set of IAC code definitions and provisioned resources;
establish at least one of a first map, a second map, or a third map;
at least some of the provisioned resources are associated with differing cloud service providers;
a first map, a second map, and a third map track configuration changes over time;
identify at least one discrepancy between a set of IAC code definitions and a provisioned resources based on at least one of a first map, a second map, or a third map;
take a remedial action;
use a third map to produce a regulatory audit;
generate at least one confidence score for at least one of a first map, a second map, or a third map;
take a remedial action when at least one confidence score is below a threshold level;
visually present at least one of a first map, a second map, or a third map via an interactive user interface;
expose an Application Programming Interface (API) for accessing at least one of a first map, a second map, or a third map;
analyze at least one of a first map, a second map, or a third map to identify at least one pattern associated with an infrastructure change;
predict future infrastructure needs based on at least one pattern;
use at least one of a first map, a second map, or a third map to identify an orphaned resource omitted from the third map;
take a remedial action based on an identified orphaned resource;
identify a vulnerability associated with at least one provisioned resource;
use at least one of a first map, a second map, or a third map to take a remedial action based on an identified vulnerability;
a remedial action includes using a third map to locate from a set of IAC code definitions an IAC code definition corresponding to at least one provisioned resource;
outputting a remediation for an IAC code definition;
detect a security incident;
use at least one of a first map, a second map, or a third map to identify a party associated with a security incident;
identify at least one provisioned resource affected by a security incident;
provisioned resources include Kubernetes resources;
IAC state data includes Helm release state data;
a set of IAC code definitions includes Helm charts
establish a first map by matching Kubernetes resources to Helm release state data based on resource kind, labels, and namespace;
establish a second map by matching Helm release state data to Helm charts based on chart metadata, template file structure, and dependent chart information;
use at least one of a first map, a second map, or a third map to trace ownership of at least one provisioned resource;
analyzing version control metadata associated with a set of IAC code definitions to identify a party responsible for at least one provisioned resource; and
version control metadata includes at least one of commit authorship, code ownership files, or deployment pipeline records.

What is claimed is:

1. A system for identifying infrastructure-as-code (IAC) associated with cloud assets, the system comprising:
at least one processor configured to:
locate IAC state data;
analyze the IAC state data to identify attributes of associated provisioned resources, wherein the IAC state data lacks manually introduced tags;
access the provisioned resources;
establish a first map between the IAC state data and the provisioned resources based on the identified attributes;
access a set of IAC code definitions;
establish a second map between the IAC state data and the set of IAC code definitions; and
based on the first map and the second map, establish a third map between the set of IAC code definitions and the provisioned resources, thereby mapping the set of IAC code definitions to the provisioned resources without requiring manual tagging of the provisioned resources.

2. The system of claim 1, wherein the identified attributes include at least one of a resource name, a resource type, a resource identifier, or a module chain.

3. The system of claim 1, wherein the provisioned resources include at least one of cloud resources, managed resources, managed computing infrastructure resources, or on-premise resources.

4. The system of claim 1, wherein the IAC state data includes at least one of Terraform state data, Helm state data, Pulumi state data, or CloudFormation stack state data.

5. The system of claim 1, wherein the set of IAC code definitions includes at least one of a Pulumi program, a Terraform module, a CloudFormation template, an ARM template, a Bicep template, or a Helm chart.

6. The system of claim 1, wherein the set of IAC code definitions includes a plurality of reusable blueprints for provisioning a plurality of resources, and wherein each provisioned resource corresponds to a single reusable blueprint.

7. The system of claim 1, wherein the at least one processor is further configured to apply at least one heuristic to disambiguate among multiple candidate matches between at least the IAC state data and the provisioned resources, the IAC state data and the set of IAC code definitions, or the set of IAC code definitions and the provisioned resources to thereby establish at least one of the first map, the second map, or the third map.

8. The system of claim 1, wherein at least some of the provisioned resources are associated with differing cloud service providers.

9. The system of claim 1, wherein the first map, the second map, and the third map track configuration changes over time.

10. The system of claim 1, wherein the at least one processor is further configured to identify at least one discrepancy between the set of IAC code definitions and the provisioned resources based on at least one of the first map, the second map, or the third map, and take a remedial action.

11. The system of claim 1, wherein the at least one processor is further configured to use the third map to produce a regulatory audit.

12. The system of claim 1, wherein the at least one processor is further configured to generate at least one confidence score for at least one of the first map, the second map, or the third map, and take a remedial action when the at least one confidence score is below a threshold level.

13. The system of claim 1, wherein the at least one processor is further configured to visually present at least one of the first map, the second map, or the third map via an interactive user interface.

14. The system of claim 1, wherein the at least one processor is further configured to expose an Application Programming Interface (API) for accessing at least one of the first map, the second map, or the third map.

15. The system of claim 1, wherein the at least one processor is further configured to analyze at least one of the first map, the second map, or the third map to identify at least one pattern associated with an infrastructure change, and to predict future infrastructure needs based on the at least one pattern.

16. The system of claim 1, wherein the at least one processor is further configured to use at least one of the first map, the second map, or the third map to identify an orphaned resource omitted from the third map, and to take a remedial action based on the identified orphaned resource.

17. The system of claim 1, wherein the at least one processor is further configured identify a vulnerability associated with at least one of the provisioned resources, and use at least one of the first map, the second map, or the third map to take a remedial action based on the identified vulnerability.

18. The system of claim 17, wherein the remedial action includes using the third map to locate from the set of IAC code definitions an IAC code definition corresponding to the at least one of the provisioned resources and outputting a remediation for the IAC code definition.

19. The system of claim 1, wherein the at least one processor is further configured to detect a security incident and use at least one of the first map, the second map, or the third map to identify a party associated with the security incident, and to identify at least one of the provisioned resources affected by the security incident.

20. The system of claim 1, wherein the provisioned resources include Kubernetes resources, the IAC state data includes Helm release state data, and the set of IAC code definitions includes Helm charts, and wherein the at least one processor is further configured to establish the first map by matching Kubernetes resources to Helm release state data based on resource kind, labels, and namespace, and establish the second map by matching Helm release state data to Helm charts based on chart metadata, template file structure, and dependent chart information.

21. The system of claim 1, wherein the at least one processor is further configured to use at least one of the first map, the second map, or the third map to trace ownership of at least one of the provisioned resources.

22. The system of claim 21, wherein tracing ownership includes analyzing version control metadata associated with the set of IAC code definitions to identify a party responsible for the at least one of the provisioned resources, wherein the version control metadata includes at least one of commit authorship, code ownership files, or deployment pipeline records.

23. A method for identifying infrastructure-as-code (IAC) associated with cloud assets, the method comprising:
locating IAC state data;
analyzing the IAC state data to identify attributes of associated provisioned resources, wherein the IAC state data lacks manually introduced tags;
accessing the provisioned resources;
establishing a first map between the IAC state data and the provisioned resources based on the identified attributes;
accessing a set of IAC code definitions;
establishing a second map between the IAC state data and the set of IAC code definitions; and
based on the first map and the second map, establishing a third map between the set of IAC code definitions and the provisioned resources, thereby mapping the set of IAC code definitions to the provisioned resources without requiring manual tagging of the provisioned resources.

24. A non-transitory computer readable medium containing instructions that when executed by at least one processor cause the at least one processor to perform operations for identifying infrastructure-as-code (IAC) associated with cloud assets, the operations comprising:
locating IAC state data;
analyzing the IAC state data to identify attributes of associated provisioned resources, wherein the IAC state data lacks manually introduced tags;
accessing the provisioned resources;
establishing a first map between the IAC state data and the provisioned resources based on the identified attributes;
accessing a set of IAC code definitions;
establishing a second map between the IAC state data and the set of IAC code definitions; and
based on the first map and the second map, establishing a third map between the set of IAC code definitions and the provisioned resources, thereby mapping the set of IAC code definitions to the provisioned resources without requiring manual tagging of the provisioned resources.
